(19) United States
(12) Patent Application Publication
(10) Pub. No.: US 2024/0251374 A1
(43) Pub. Date: Jul. 25, 2024

(54) CELLULAR NETWORK-BASED POSITIONING FOR NON-TERRESTRIAL NETWORK

(71) Applicant: QUALCOMM Incorporated, San Diego, CA (US)

(72) Inventors: Chao WEI, Beijing (CN); Jing DAI, Beijing (CN); Qiaoyu LI, Beijing (CN); Hao XU, Beijing (CN); Danlu ZHANG, San Diego, CA (US)

(21) Appl. No.: 18/293,324

(22) PCT Filed: Sep. 29, 2021
(86) PCT No.: PCT/CN2021/121614

§ 371 Date: Jan. 29, 2024

(51) Int. Cl. H04W 64/00; G01S 5/10; G01S 13/87

(52) U.S. Cl. CPC H04W 64/00; G01S 5/10; G01S 13/876

(57) ABSTRACT

Aspects presented herein may enable a positioning entity (e.g., a UE, a base station, a TRP, or an LMF, etc.) to take changes in propagation delay into consideration when calculating RTT or measuring Rx-Tx timing difference for signals transmitted between a UE and a non-terrestrial device. In one aspect, a UE measures a plurality of PRSs transmitted from a non-terrestrial device. The UE calculates a propagation delay change between the UE and the non-terrestrial device based on a TDOA of the plurality of PRSs. The UE transmits, to an LMF or a location server, a UE Rx-Tx time difference associated with a UE positioning session and the propagation delay change.

### TECHNICAL FIELD

The present disclosure relates generally to communication systems, and more particularly, to wireless communications involving positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus measures a plurality of positioning reference signals (PRSs) transmitted from a non-terrestrial device. The apparatus calculates a propagation delay change between the UE and the non-terrestrial device based on a time difference of arrival (TDOA) of the plurality of PRSs. The apparatus transmits, to a location management function (LMF) or a location server, a UE reception-transmission (Rx-Tx) time difference associated with a UE positioning session and the propagation delay change.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements in accordance with various aspects of the present disclosure.

FIG. 5A is a diagram illustrating an example of downlink-positioning reference signal (DL-PRS) transmitted from multiple transmission-reception points (TRPs)/base stations in accordance with various aspects of the present disclosure.

FIG. 5B is a diagram illustrating an example of uplink-sounding reference signal (UL-SRS) transmitted from a UE in accordance with various aspects of the present disclosure.

FIG. 6 is a diagram illustrating an example of estimating a position of a UE based on multi-round trip time (RTT) measurements from multiple base stations or TRPs in accordance with various aspects of the present disclosure.

FIG. 7 is a diagram illustrating an example of time delay for transmitting and receiving a signal in accordance with various aspects of the present disclosure.

FIG. 8 is a diagram illustrating an example of a single-sided RTT measurement between a PRS and an SRS in accordance with various aspects of the present disclosure.

FIG. 9 is a communication flow illustrating an example multi-RTT positioning procedure in accordance with various aspects of the present disclosure.

FIG. 10 is a diagram illustrating an example RTT-based positioning for non-terrestrial network (NTN) in accordance with various aspects of the present disclosure.

FIG. 11 is a diagram illustrating an example of calculating an RTT between a UE and a base station in accordance with various aspects of the present disclosure.

FIG. 12 is a communication flow illustrating an example of a UE measuring and reporting propagation delay change for a UE positioning session associated with an NTN in accordance with various aspects of the present disclosure.

FIG. 13A is a diagram illustrating an example of a UE receiving two PRSs based on the same reference system timing in accordance with various aspects of the present disclosure.

FIG. 13B is a diagram illustrating an example of a UE receiving two PRSs based on different reference system timing in accordance with various aspects of the present disclosure.

FIG. 14 is a diagram illustrating an example of a UE aligning its SRS transmission with a PRS transmission from a base station in accordance with various aspects of the present disclosure.

FIG. 15 is a diagram illustrating an example of a UE aligning its SRS transmissions with PRS transmissions from multiple base stations in accordance with various aspects of the present disclosure.

FIG. 16 is a flowchart of a method of wireless communication in accordance with aspects presented herein.

FIG. 17 is a flowchart of a method of wireless communication in accordance with aspects presented herein.

FIG. 18 is a diagram illustrating an example of a hardware implementation for an example apparatus in accordance with aspects presented herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

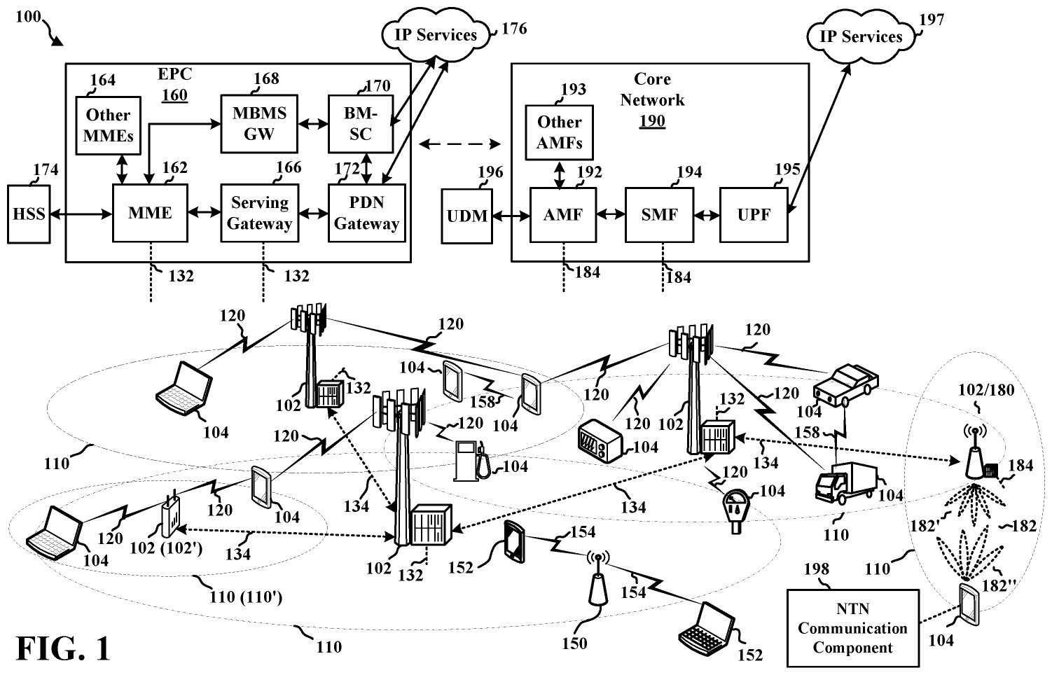

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

Aspects presented herein may improve positioning procedures associated with an NTN, where RTT between a UE and a non-terrestrial device (e.g., an aircraft base station, or a satellite base station, etc.) associated with the NTN may be calculated/estimated with a higher accuracy. Aspects presented herein may enable a positioning entity (e.g., a UE, a base station, a TRP, or an LMF, etc.) to take changes in propagation delay into consideration when calculating RTT or measuring Rx-Tx timing difference for signals transmitted between a UE and a non-terrestrial device. Aspects presented herein may further improve the accuracy of a positioning session associated with an NTN, where the transmission timing of reference signals transmitted from a UE and a non-terrestrial device in a positioning session may be adjusted to be aligned or close in time. As such, the reference signals are more likely to be received based on a similar or a same channel condition or propagation delay. In certain aspects, the UE 104 may include an NTN communication component 198 configured to measure the propagation delay for signals transmitted between a UE and a non-terrestrial device and report the propagation delay to a serving base station and/or a location server with RTT measurements. In one configuration, the NTN communication component 198 may be configured to measure a plurality of PRSs transmitted from a non-terrestrial device. In such configuration, the NTN communication component 198 may calculate a propagation delay change between the UE and the non-terrestrial device based on a TDOA of the plurality of PRSs. In such configuration, the NTN communication component 198 may transmit, to an LMF or a location server, a UE Rx-Tx time difference associated with a UE positioning session and the propagation delay change.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

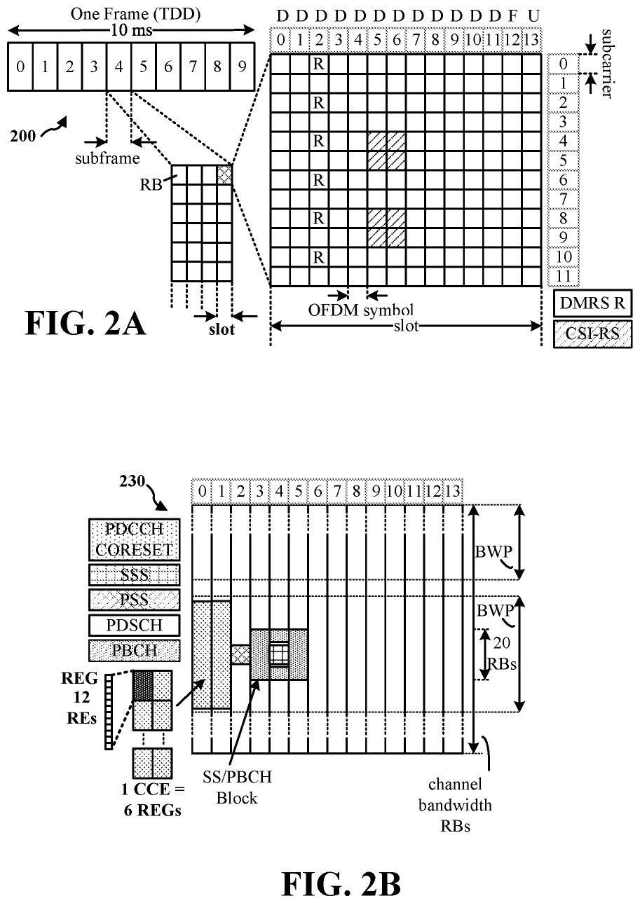

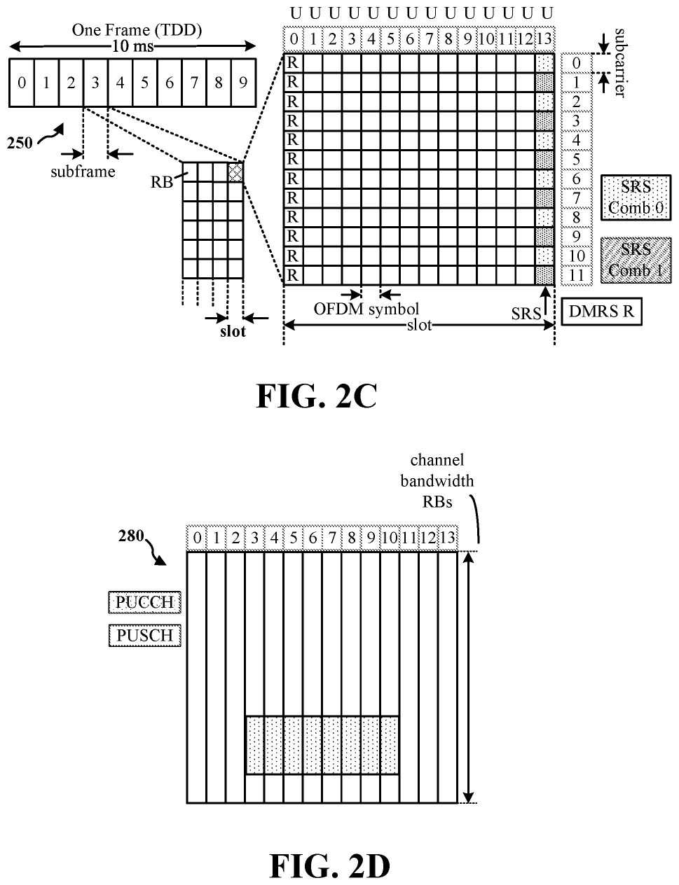

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

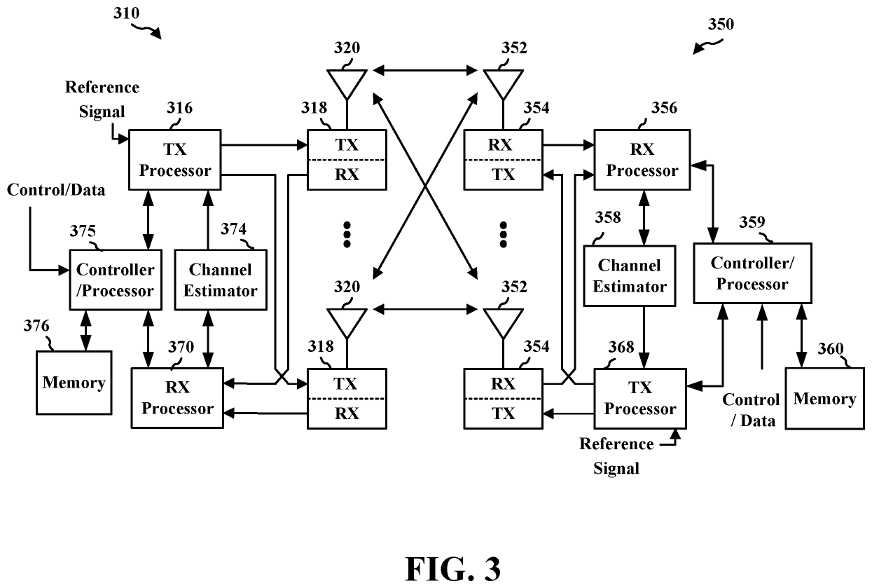

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the NTN communication component 198 of FIG. 1.

A network may support a number of cellular network-based positioning technologies, such as downlink-based, uplink-based, and/or downlink-and-uplink-based positioning methods. Downlink-based positioning methods may include an observed time difference of arrival (OTDOA) (e.g., in LTE), a downlink time difference of arrival (DL-TDOA) (e.g., in NR), and/or a downlink angle-of-departure (DL-AoD) (e.g., in NR). In an OTDOA or DL-TDOA positioning procedure, a UE may measure the differences between each time of arrival (ToA) of reference signals (e.g., positioning reference signals (PRSs)) received from pairs of base stations, referred to as reference signal time difference (RSTD) measurements or time difference of arrival (TDOA) measurements, and report them to a positioning entity (e.g., a location management function (LMF)). For example, the UE may receive identifiers (IDs) of a reference base station (e.g., a serving base station) and multiple non-reference base stations in assistance data. The UE may then measure the RSTD between the reference base station and each of the non-reference base stations. Based on the known locations of the involved base stations and the RSTD measurements, the positioning entity can estimate a location of the UE. In other words, a position of the UE may be estimated based on measuring reference signals transmitted between the UE and one or more base stations and/or transmission-reception points (TRPs) of the one or more base stations. As such, the PRSs may enable UEs to detect and measure neighbor TRPs, and to perform positioning based on the measurement. For purposes of the present disclosure, the suffixes “-based” and “-assisted” may refer respectively to the node that is responsible for making the positioning calculation (and which may also provide measurements) and a node that provides measurements (but which may not make the positioning calculation). For example, an operation in which measurements are provided by a UE to a base station/positioning entity to be used in the computation of a position estimate may be described as “UE-assisted,” “UE-assisted positioning,” and/or “UE-assisted position calculation” while an operation in which a UE computes its own position may be described as “UE-based,” “UE-based positioning,” and/or “UE-based position calculation.”

For DL-AoD positioning, the positioning entity may use a beam report from the UE of received signal strength measurements of multiple downlink transmit beams to determine the angle(s) between the UE and the transmitting base station(s). The positioning entity may then estimate the location of the UE based on the determined angle(s) and the known location(s) of the transmitting base station(s).

Uplink-based positioning methods may include UL-TDOA and UL-AoA. UL-TDOA is similar to DL-TDOA, but is based on uplink reference signals (e.g., sounding reference signals (SRSs)) transmitted by the UE. For UL-AoA positioning, one or more base stations may measure the received signal strength of one or more uplink reference signals (e.g., SRSs) received from a UE on one or more uplink receive beams. The positioning entity may use the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods may include enhanced cell-ID (E-CID) positioning and multi-round-trip-time (RTT) positioning (also referred to as “multi-cell RTT”). In an RTT procedure, an initiator (a base station or a UE) transmits an RTT measurement signal (e.g., a PRS or SRS) to a responder (a UE or a base station), which transmits an RTT response signal (e.g., an SRS or a PRS) back to the initiator. The RTT response signal may include the difference between the ToA of the RTT measurement signal and the transmission time of the RTT response signal, referred to as the reception-to-transmission (Rx-Tx) time difference. The initiator may calculate the difference between the transmission time of the RTT measurement signal and the ToA of the RTT response signal, referred to as the transmission-to-reception (Tx-Rx) time difference. The propagation time (also referred to as the “time of flight”) between the initiator and the responder may be calculated from the Tx-Rx and Rx-Tx time differences. Based on the propagation time and the known speed of light, the distance between the initiator and the responder may be determined. For multi-RTT positioning, a UE may perform an RTT procedure with multiple base stations to enable its location to be determined (e.g., using multilateration) based on the known locations of the base stations. RTT and multi-RTT methods may be combined with other positioning techniques, such as UL-AoA and DL-AoD, to improve location accuracy.

The E-CID positioning method may be based on radio resource management (RRM) measurements. In E-CID, the UE may report the serving cell ID and the timing advance (TA), as well as the identifiers, estimated timing, and signal strength of detected neighbor base stations. The location of the UE is then estimated based on this information and the known locations of the base station(s).

To assist positioning operations, a location server (e.g., a location server, an LMF, or an SLP) may provide assistance data to the UE. For example, the assistance data may include identifiers of the base stations (or the cells/TRPs of the base stations) from which to measure reference signals, the reference signal configuration parameters (e.g., the number of consecutive positioning subframes, periodicity of positioning subframes, muting sequence, frequency hopping sequence, reference signal identifier, reference signal bandwidth, etc.), and/or other parameters applicable to the particular positioning method. Alternatively, the assistance data may originate directly from the base stations (e.g., in periodically broadcasted overhead messages, etc.). In some cases, the UE may be able to detect neighbor network nodes without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may also be referred to as a position estimate, location, position, position fix, fix, or the like. A location estimate may be geodetic and include coordinates (e.g., latitude, longitude, and possibly altitude) or may be civic and include a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence). For purposes of the present disclosure, reference signals may include PRS, tracking reference signals (TRS), phase tracking reference signals (PTRS), cell-specific reference signals (CRS), CSI-RS, demodulation reference signals (DMRS), PSS, SSS, SSBs, SRS, etc., depending on whether the illustrated frame structure is used for uplink or downlink communication. In some examples, a collection of resource elements (REs) that are used for transmission of PRS may be referred to as a “PRS resource.” The collection of resource elements may span multiple PRBs in the frequency domain and one or more consecutive symbol(s) within a slot in the time domain. In a given OFDM symbol in the time domain, a PRS resource may occupy consecutive PRBs in the frequency domain. In other examples, a “PRS resource set” may refer to a set of PRS resources used for the transmission of PRS signals, where each PRS resource may have a PRS resource ID. In addition, the PRS resources in a PRS resource set may be associated with a same TRP. A PRS resource set may be identified by a PRS resource set ID and may be associated with a particular TRP (e.g., identified by a TRP ID). In addition, the PRS resources in a PRS resource set may have a same periodicity, a common muting pattern configuration, and/or a same repetition factor across slots. The periodicity may be a time from a first repetition of a first PRS resource of a first PRS instance to the same first repetition of the same first PRS resource of the next PRS instance. For example, the periodicity may have a length selected from 2\hat{ }μ*{4, 5, 8, 10, 16, 20, 32, 40, 64, 80, 160, 320, 640, 1280, 2560, 5120, 10240} slots, where μ=0, 1, 2, 3. The repetition factor may have a length selected from {1, 2, 4, 6, 8, 16, 32} slots. A PRS resource ID in a PRS resource set may be associated with a single beam (or beam ID) transmitted from a single TRP (where a TRP may transmit one or more beams). That is, each PRS resource of a PRS resource set may be transmitted on a different beam, and as such, a “PRS resource,” or simply “resource,” also can be referred to as a “beam.” In some examples, a “PRS instance” or “PRS occasion” may be one instance of a periodically repeated time window (such as a group of one or more consecutive slots) where PRS are expected to be transmitted. A PRS occasion also may be referred to as a “PRS positioning occasion,” a “PRS positioning instance,” a “positioning occasion,” “a positioning instance,” a “positioning repetition,” or simply an “occasion,” an “instance,” and/or a “repetition,” etc.

A positioning frequency layer (PFL) (which may also be referred to as a “frequency layer”) may be a collection of one or more PRS resource sets across one or more TRPs that have the same values for certain parameters. Specifically, the collection of PRS resource sets may have a same subcarrier spacing and cyclic prefix (CP) type (e.g., meaning all numerologies supported for PDSCHs are also supported for PRS), the same Point A, the same value of the downlink PRS bandwidth, the same start PRB (and center frequency), and/or the same comb-size, etc. The Point A parameter may take the value of a parameter ARFCN-ValueNR (where “ARFCN” stands for “absolute radio-frequency channel number”) and may be an identifier/code that specifies a pair of physical radio channel used for transmission and reception. In some examples, a downlink PRS bandwidth may have a granularity of four PRBs, with a minimum of 24 PRBs and a maximum of 272 PRBs. In other examples, up to four frequency layers may be configured, and up to two PRS resource sets may be configured per TRP per frequency layer.

The concept of a frequency layer may be similar to a component carrier (CC) and a BWP, where CCs and BWPs may be used by one base station (or a macro cell base station and a small cell base station) to transmit data channels, while frequency layers may be used by multiple (e.g., three or more) base stations to transmit PRS. A UE may indicate the number of frequency layers it is capable of supporting when the UE sends the network its positioning capabilities, such as during a positioning protocol session. For example, a UE may indicate whether it is capable of supporting one or four PFLs.

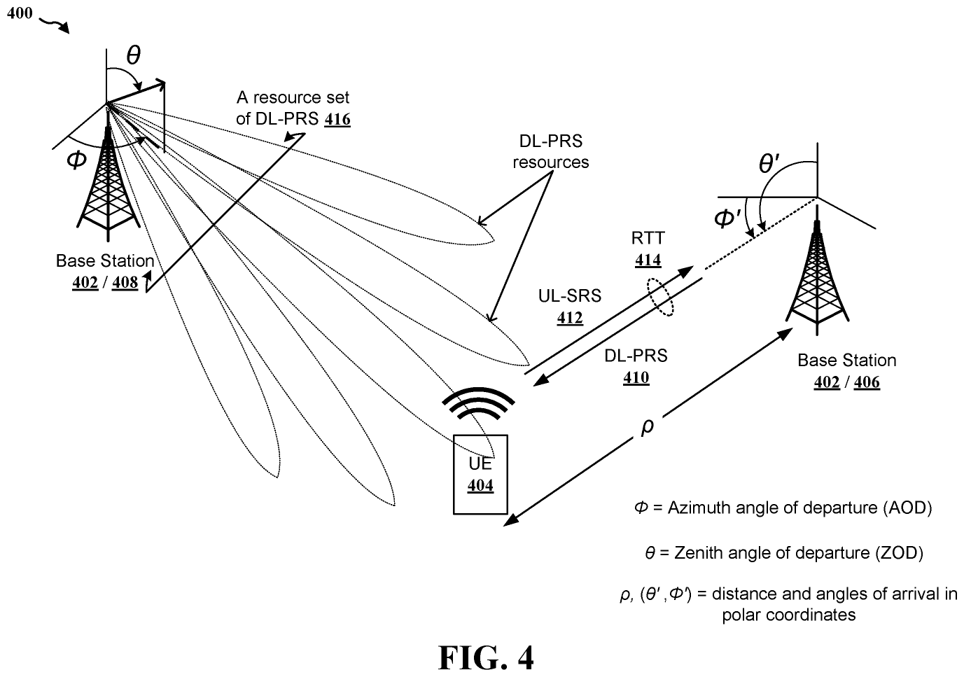

FIG. 4 is a diagram 400 illustrating an example of a UE positioning based on reference signal measurements in accordance with various aspects of the present disclosure. In one example, a location of UE 404 may be estimated based on multi-cell round trip time (multi-RTT) measurements, where multiple base stations 402 may perform round trip time (RTT) measurements for signals transmitted to and received from the UE 404 to determine the approximate distance of UE 404 with respect to each of the multiple base stations 402. Similarly, the UE 404 may perform RTT measurements for signals transmitted to and received from the base stations 402 to determine the approximate distance of each base station with respect to the UE 404. Then, based at least in part on the approximate distances of UE 404 with respect to the multiple base stations 402, a location management function (LMF) that is associated with the base stations 402 and/or the UE 404 may estimate the position of UE 404. For example, a base station 406 may transmit at least one downlink positioning reference signal (DL-PRS) 410 to the UE 404, and may receive at least one uplink sounding reference signal (UL-SRS) 412 transmitted from the UE 404. Based at least in part on measuring an RTT 414 between the DL-PRS 410 transmitted and the UL-SRS 412 received, the base station 406 or an LMF associated with the base station 406 may identify the position of UE 404 (e.g., distance) with respect to the base station 406. Similarly, the UE 404 may transmit UL-SRS 412 to the base station 406, and may receive DL-PRS 410 transmitted from the base station 406. Based at least in part on measuring the RTT 414 between the UL-SRS 412 transmitted and the DL-PRS 410 received, the UE 404 or an LMF associated with the UE 404 may identify the position of base station 406 with respect to the UE 404. The multi-RTT measurement mechanism may be initiated by the LMF that is associated with the base station 406/408 and/or the UE 404. A base station may configure UL-SRS resources to a UE via radio resource control (RRC) signaling. In some examples, the UE and the base station (or TRPs of the base station) may report the multi-RTT measurements to the LMF, and the LMF may estimate the position of the UE based on the reported multi-RTT measurements.

In other examples, a position of a UE may be estimated based on multiple antenna beam measurements, where a downlink angle of departure (DL-AoD) and/or uplink angle of arrival (UL-AoA) of transmissions between a UE and one or more base stations/TRPs may be used to estimate the position of the UE and/or the distance of the UE with respect to each base station/TRP. For example, referring back to FIG. 4, with regard to the DL-AoD, the UE 404 may perform reference signal received power (RSRP) measurements for a set of DL-PRS 416 transmitted from multiple transmitting beams (e.g., DL-PRS beams) of a base station 408, and the UE 404 may provide the DL-PRS beam measurements to a serving base station (or to the LMF associated with the base station). Based on the DL-PRS beam measurements, the serving base station or the LMF may derive the azimuth angle (e.g., Φ) of departure and the zenith angle (e.g., θ) of departure for DL-PRS beams of the base station 408. Then, the serving base station or the LMF may estimate the position of UE 404 with respect to the base station 408 based on the azimuth angle of departure and the zenith angle of departure of the DL-PRS beams. Similarly, for the UL-AoA, a position of a UE may be estimated based on UL-SRS beam measurements measured at different base stations, such as at the base stations 402. Based on the UL-SRS beam measurements, a serving base station or an LMF associated with the serving base station may derive the azimuth angle of arrival and the zenith angle of arrival for UL-SRS beams from the UE, and the serving base station or the LMF may estimate the position of the UE and/or the UE distance with respect to each of the base stations based on the azimuth angle of arrival and the zenith angle of arrival of the UL-SRS beams.

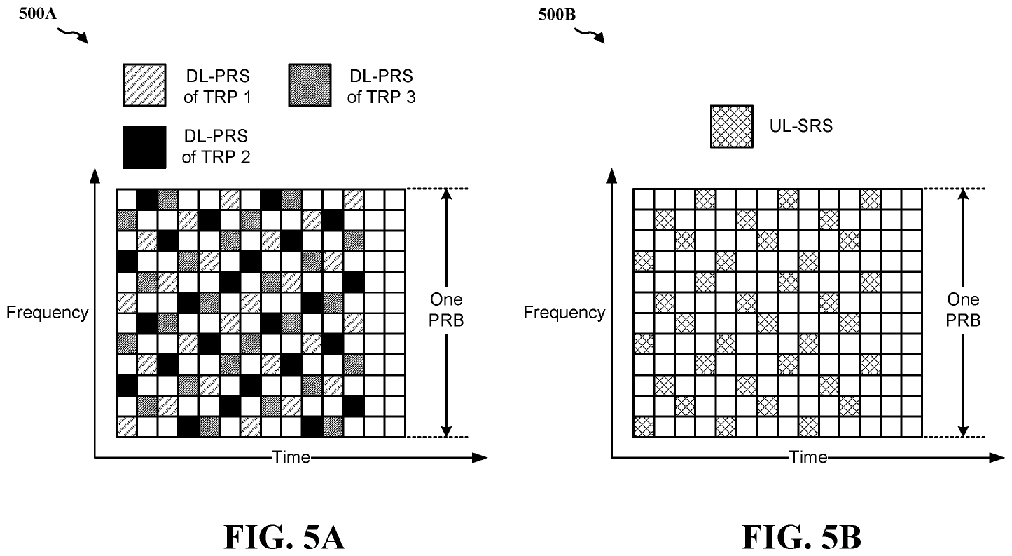

FIG. 5A is a diagram 500A illustrating an example of DL-PRS transmitted from multiple TRPs/base stations in accordance with various aspects of the present disclosure. In one example, a serving base station may configure DL-PRS to be transmitted from one or more TRPs/base stations within a slot or across multiple slots. If the DL-PRS is configured to be transmitted within a slot, the serving base station may configure the starting resource element in time and frequency from each of the one or more TRPs/base stations. If the DL-PRS is configured to be transmitted across multiple slots, the serving base station may configure gaps between DL-PRS slots, periodicity of the DL-PRS, and/or density of the DL-PRS within a period. The serving base station also may configure the DL-PRS to start at any physical resource block (PRB) in the system bandwidth. In one example, the system bandwidth may range from 24 to 276 PRBs in steps of 4 PRBs (e.g., 24, 28, 32, 36, etc.). The serving base station may transmit the DL-PRS in PRS beams, where a PRS beam may be referred to as a “PRS resource” and a full set of PRS beams transmitted from a TRP on a same frequency may be referred to as a “PRS resource set” or a “resource set of PRS,” such as described in connection with FIG. 4. As shown by FIG. 5A, the DL-PRS transmitted from different TRPs and/or from different PRS beams may be multiplexed across symbols or slots.

In some examples, each symbol of the DL-PRS may be configured with a comb-structure in frequency, where the DL-PRS from a base station or a TRP may occupy every N^{th} subcarrier. The comb value N may be configured to be 2, 4, 6, or 12. The length of the PRS within one slot may be a multiple of N symbols and the position of the first symbol within a slot may be flexible as long as the slot consists of at least N PRS symbols. The diagram 500A shows an example of a comb-6 DL-PRS configuration, where the pattern for the DL-PRS from different TRPs/base stations may be repeated after six (6) symbols.

FIG. 5B is a diagram 500B illustrating an example of UL-SRS transmitted from a UE in accordance with various aspects of the present disclosure. In one example, the UL-SRS from a UE may be configured with a comb-4 pattern, where the pattern for UL-SRS may be repeated after four (4) symbols. Similarly, the UL-SRS may be configured in an SRS resource of an SRS resource set, where each SRS resource may correspond to an SRS beam, and the SRS resource sets may correspond to a collection of SRS resources (e.g., beams) configured for a base station/TRP. In some examples, the SRS resources may span 1, 2, 4, 8, or 12 consecutive OFDM symbols. In other examples, the comb size for the UL-SRS may be configured to be 2, 4, or 8.

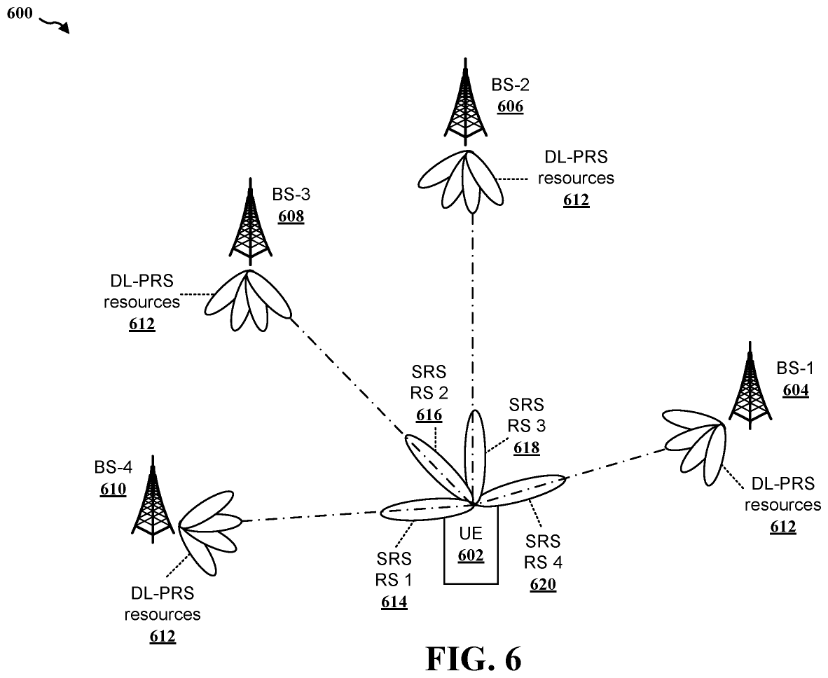

FIG. 6 is a diagram 600 illustrating an example of estimating a position of a UE based on multi-RTT measurements from multiple base stations or TRPs in accordance with various aspects of the present disclosure. A UE 602 may be configured by a serving base station to decode DL-PRS resources 612 that correspond to and are transmitted from a first base station (BS) 604, a second BS 606, a third BS 608, and a fourth BS 610. The UE 602 may also be configured to transmit UL-SRSs on a set of UL-SRS resources, which may include a first SRS resource 614, a second SRS resource 616, a third SRS resource 618, and a fourth SRS resource 620, such that the serving cell(s), e.g., the first BS 604, the second BS 606, the third BS 608, and the fourth BS 610, and as well as other neighbor cell(s), may be able to measure the set of the UL-SRS resources transmitted from the UE 602. For multi-RTT measurements based on DL-PRS and UL-SRS, as there may be an association between a measurement of a UE for the DL-PRS and a measurement of a base station for the UL-SRS, the smaller the gap is between the DL-PRS measurement of the UE and the UL-SRS transmission of the UE, the better the accuracy may be for estimating the position of the UE and/or the distance of the UE with respect to each BS.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL-PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.”

In some scenarios, a positioning procedure may be associated with one or more non-terrestrial networks (NTNs). In some examples, NTNs may refer to networks, or segments of networks, using an airborne (e.g., an aircraft) or satellites (e.g., low earth orbit (LEO) satellites, medium earth orbit (MEO) satellites, geosynchronous (GEO) satellites, and/or high-altitude pseudo satellite (HAPS), etc.) for transmission. For example, an NTN may support direct communications between a UE (e.g., a handset, a mobile device, a mobile phone, etc.) and a satellite (e.g., an LEO satellite, or a GEO satellite, etc.), where the UE may transmit text messages and/or voice service to another UE via the satellite. In some aspects, determining a position of a UE may be an important factor for an NTN. For example, location information of a UE may be used in a random access network (RAN) for an initial synchronization, uplink timing and frequency pre-compensation, mobility, and/or handover, etc. In addition, an NTN may support different types of UEs, such as UEs with global navigation satellite system (GNSS) support (e.g., the positions of the UEs may be determined via global positioning system (GPS)) and/or UEs without GNSS support.

One advantage of a UE performing a positioning session with an NTN over GNSS (e.g., with GNSS support) is that the communication link between the UE and a satellite may enable the UE to interact with the satellite. For example, the PRS signals transmitted from a satellite may be tailored to or configured for a specific user or a specific device. As such, the performance and/or the accuracy of a positioning of a UE based on GNSS (e.g., based on GPS) may further be supplemented with the assistance of an NTN as the UE and/or the satellite may exchange positioning related information with each other.

On the other hand, a UE may also perform a positioning session with an NTN without GNSS support. For examples, for UEs without GNSS support, the network-based positioning methods and mechanisms discussed in connection with FIGS. 4 to 6 (e.g., multi-RTT, and/or OTDOA, etc.) may also be used for determine the location of the UE. For purposes of the present disclosure, an NTN may include just NTN cell(s), or a mix of NTN cell(s) and ground cell(s). As such, for a positioning operation associated with an NTN, the positioning operation may involve NTN cell(s) without ground cell(s), a mix of NTN and ground cells, and/or hybrid solutions involving NTN cells, ground cells, GNSS satellites, and/or other ground based positioning reference points such as WiFi, Bluetooth, etc.

For a positioning session based on multi-RTT, a UE and one or more base stations (or TRPs) may measure and report their Rx-Tx timing difference to a location server (e.g., an LMF) separately. The report may include time-stamps (e.g., SFN and/or slot number) at which the measurements for the Rx-Tx timing difference are performed, which may be based on which RTT is to be computed between the UE and the one or more base stations. In some examples, the Rx-Tx timing difference may be specified to be with a range of plus-minus (+/−) 500 μs (e.g., for a quantization of 21 bits with a step size of Tc=0.5 ns), and the corresponding time stamp may be limited within a duration of 10.24 seconds. Thus, UL and DL measurements may be performed at a different time by the UE and/or the one or more base stations.

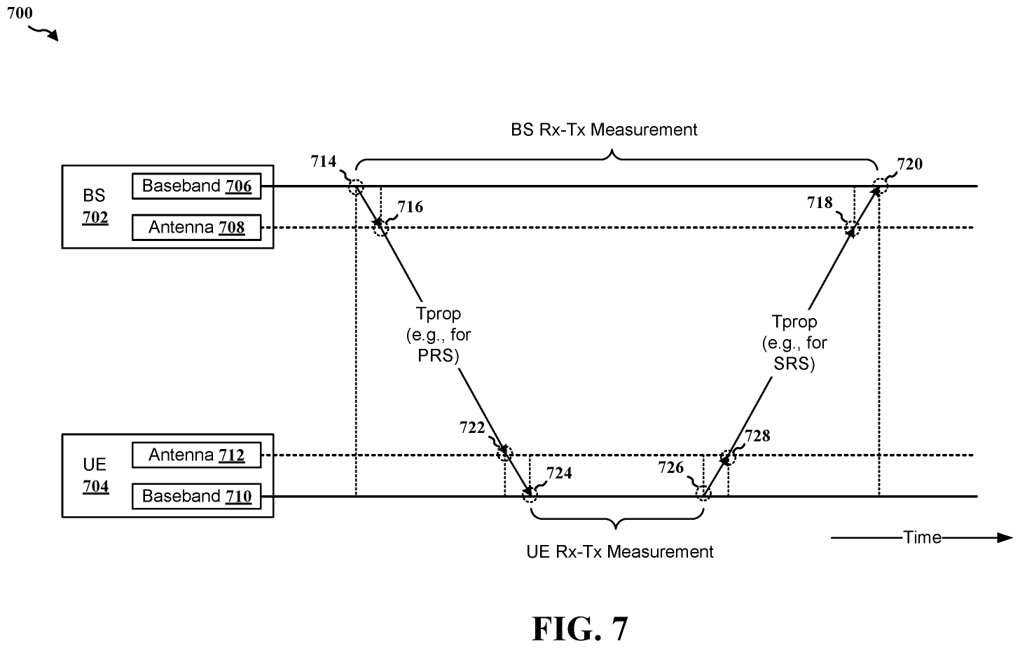

FIG. 7 is a diagram 700 illustrating an example RTT measurement in accordance with various aspects of the present disclosure. A base station 702 may include a baseband 706 and an antenna 708. When the base station 702 transmits a signal (e.g., a PRS) to a UE 704, there may be a time delay from the time when the signal is generated at the baseband 706 (e.g., as shown at 714) to the time when the signal is transmitted from the antenna 708 (e.g., as shown at 716). When the base station 702 receives a signal (e.g., an SRS) transmitted from the UE 704, there may be a time delay from the time when the signal arrives at the antenna 708 (e.g., as shown at 718) to the time when the signal is digitized and time-stamped at the baseband 706 (e.g., as shown at 720). Similarly, the UE 704 may include a baseband 710 and an antenna 712. When the UE 704 receives a signal (e.g., a PRS) transmitted from the base station 702, there may be a time delay from the time when the signal arrives at the antenna 712 (e.g., as shown at 722) to the time when the signal is digitized and time-stamped at the baseband 710 (e.g., as shown at 724). When the UE 704 transmits a signal (e.g., an SRS) to the base station 702, there may be a time delay from the time when the signal is generated at the baseband 710 (e.g., as shown at 726) to the time when the signal is transmitted from the antenna 712 (e.g., as shown at 728). In some examples, the time delay(s) between the baseband and the antenna may cause the base station 702 and/or the UE 704's Rx-Tx measurements between transmitted signals and received signals to be inaccurate, which may reduce the accuracy of the positioning. While the timing delay may be compensated/calibrated, the compensation/calibration may not be perfect and may result in Rx timing error and/or Tx timing error.

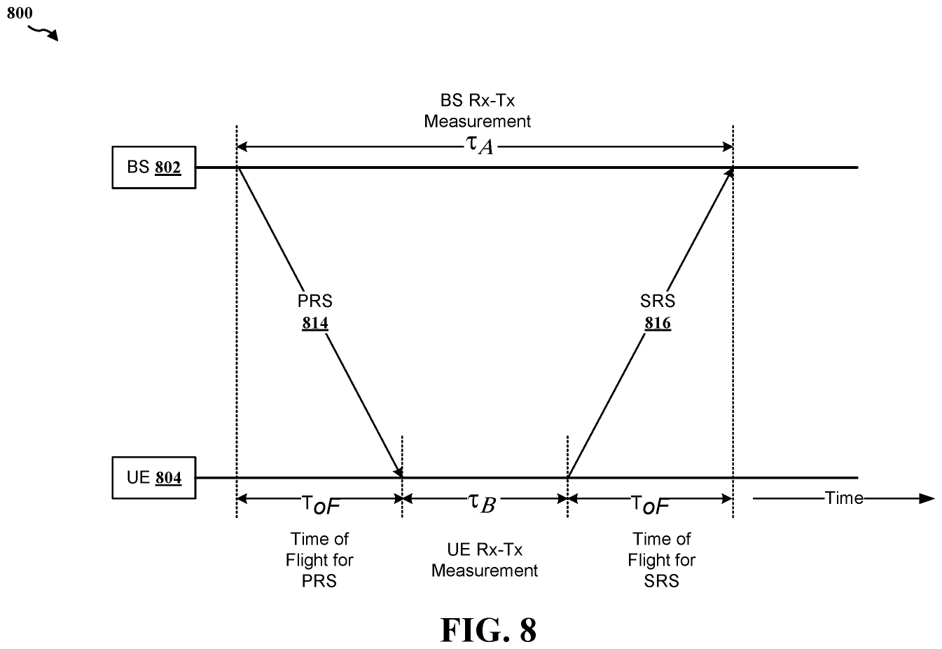

FIG. 8 is a diagram 800 illustrating an example of a single-sided RTT measurement between a PRS 814 transmitted by a base station 802 and an SRS transmitted by a UE 804 in accordance with various aspects of the present disclosure. In one example, T_{oF} may denote a time of flight of a reference signal, such as a PRS 814 or an SRS 816; τ_{A} may denote an Rx-Tx time difference between a time in which the PRS 814 is transmitted from the base station 802 and a time in which the SRS 816 is received by the base station 802, and τ_{B} may denote an Rx-Tx time difference between a time in which the PRS 814 is received by the UE 804 and a time in which the SRS 816 is transmitted from the UE 804. For purposes of the present disclosure, a UE Rx-Tx time difference (e.g., τ_{B}) may be defined as T_{UE-RX}-T_{UE-TX}, where the T_{UE-RX} may be the UE received timing of a downlink subframe #i from a positioning node (e.g., a base station, or a TRP, etc.), defined by the first detected path in time, and the T_{UE-TX} may be the UE transmit timing of an uplink subframe #j that is closest in time to the subframe #i received from the positioning node. Multiple DL PRS resources may be used to determine the start of one subframe of the first arrival path of the TP. A base station (gNB/BS) Rx-Tx time difference (e.g., τ_{A}) may be defined as T_{gNB-RX}−T_{gNB-TX}, where the T_{gNB-RX} may be the positioning node received timing of an uplink subframe #i containing SRS associated with a UE, defined by the first detected path in time, and the T_{gNB-TX} may be the positioning node transmit timing of a downlink subframe #j that is closest in time to the subframe #i received from the UE. Multiple SRS resources for positioning may be used to determine the start of one subframe containing SRS.

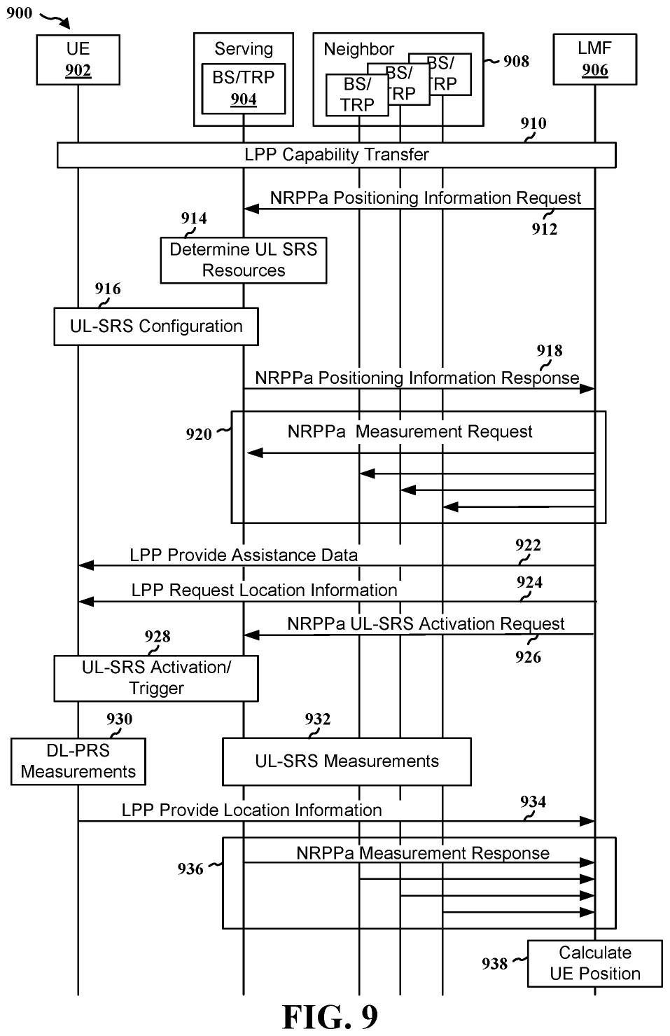

FIG. 9 is a communication flow 900 illustrating an example multi-RTT positioning procedure in accordance with various aspects of the present disclosure. The numberings associated with the communication flow 900 do not specify a particular temporal order and are merely used as references for the communication flow 900. In addition, a DL-only and/or an UL-only positioning may use a subset or subsets of this multi-RTT positioning procedure.

At 910, an LMF 906 may request one or more positioning capabilities from a UE 902 (e.g., from a target device). In some examples, the request for the one or more positioning capabilities from the UE 902 may be associated with an LTE Positioning Protocol (LPP). For example, the LMF 906 may request the positioning capabilities of the UE 902 using an LPP capability transfer procedure.

At 912, the LMF 906 may request UL SRS configuration information for the UE 902. The LMF 906 may also provide assistance data specified by a serving base station 904 (e.g., pathloss reference, spatial relation, and/or SSB configuration(s), etc.). For example, the LMF 906 may send an NR Positioning Protocol A (NRPPa) positioning information request message to the serving base station 904 to request UL information for the UE 902.

At 914, the serving base station 904 may determine resources available for UL SRS, and at 916, the serving base station 904 may configure the UE 902 with one or more UL SRS resource sets based on the available resources.

At 918, the serving base station 904 may provide UL SRS configuration information to the LMF 906, such as via an NRPPa positioning information response message.

At 920, the LMF 906 may select one or more candidate neighbor BSs/TRPs 908, and the LMF 906 may provide an UL SRS configuration to the one or more candidate neighbor BSs/TRPs 908 and/or the serving base station 904, such as via an NRPPa measurement request message. The message may include information for enabling the one or more candidate neighbor BSs/TRPs 908 and/or the serving base station to perform the UL measurements.

At 922, the LMF 906 may send a LPP provide assistance data message to the UE 902. The message may include specified assistance data for the UE 902 to perform the DL measurements.

At 924, the LMF 906 may send a LPP request location information message to the UE 902 to request multi-RTT measurements.

At 926, for semi-persistent or aperiodic UL SRS, the LMF 906 may request the serving base station 904 to activate/trigger the UL SRS in the UE 902. For example, the LMF 906 may request activation of UE SRS transmission by sending an NRPPa positioning activation request message to the serving base station 904.

At 928, the serving base station 904 may activate the UE SRS transmission and send an NRPPa positioning activation response message. In response, the UE 902 may begin the UL-SRS transmission according to the time domain behavior of UL SRS resource configuration.

At 930, the UE 902 may perform the DL measurements from the one or more candidate neighbor BSs/TRPs 908 and/or the serving base station 904 provided in the assistance data. At 932, each of the configured one or more candidate neighbor BSs/TRPs 908 and/or the serving base station 904 may perform the UL measurements.

At 934, the UE 902 may report the DL measurements to the LMF 906, such as via an LPP provide location information message.

At 936, each of the one or more candidate neighbor BSs/TRPs 908 and/or the serving base station 904 may report the UL measurements to the LMF 906, such as via an NRPPa measurement response message.

At 938, the LMF 906 may determine the RTTs from the UE 902 and BS/TRP Rx-Tx time difference measurements for each of the one or more candidate neighbor BSs/TRPs 908 and/or the serving base station 904 for which corresponding UL and DL measurements were provided at 934 and 936, and the LMF 906 may calculate the position of the UE 902.

In some scenarios, as non-terrestrial base stations (e.g., aircrafts, and/or satellites, etc.) may be moving at a high speed, propagation delay for an NTN in orders of magnitude may be higher than terrestrial system (e.g., the terrestrial base station) and the long RTT may specify a larger value range for the Rx-Tx timing difference. For example, an RTT for transmissions between a UE and a LEO satellite that is 600 km above the ground may take up to 21 ms, an RTT for transmissions between a UE and a MEO satellite that is 1200 km above the ground may take up to 42 ms, and an RTT for transmissions between a UE and a GEO satellite may take up to 542 ms, etc.

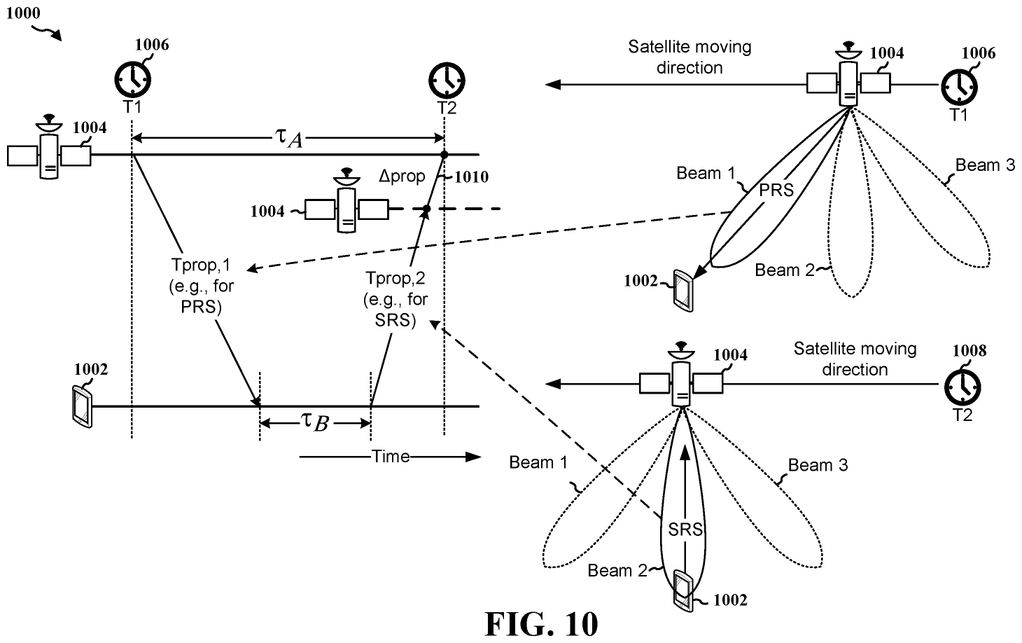

FIG. 10 is a diagram 1000 illustrating an example RTT-based positioning associated with an NTN in accordance with various aspects of the present disclosure. In some examples, such as in an LEO-based NTN, due to the high speed satellite movement, propagation delay may be different or changed between DL PRS and UL SRS transmissions. For example, as shown at 1006, at a first point in time (T1), a satellite 1004 may transmit a DL PRS to a UE 1002 via a first beam (Beam 1) of the satellite, and the UE 1002 may receive the DL PRS after a first propagation time (T_{prop,1}). Then, as shown at 1008, at a second point in time (T2), in response to the received DL PRS, the UE 1002 may transmit an UL SRS to the satellite 1004. However, due to the high moving speed of the satellite, the distance between the satellite 1004 and the UE 1002 and/or the channel condition between the satellite 1004 and the UE 1002 may have changed significantly or by a margin. For example, at the second point in time, the satellite 1004 may receive the UL SRS from the UE 1002 via a second beam (Beam 2) after a second propagation time (T_{prop,2}), where the channel conditions associated with the first beam and the second beam of the satellite 1004 may be quite different. As shown at 1010, this may result in a change of the propagation delay between the DL PRS and the UL SRS which may not be ignored and may affect positioning accuracy. In addition, in some networks, there may be a maximum differential delay specified or allowed for change in a propagation delay, such as up to 3.18 ms for a LEO cell. That is, if the time gap between a UE (e.g., the UE 1002) and a base station (e.g., the satellite 1004) measuring Rx-Tx timing difference is larger than an NTN beam serving time (e.g., 20 seconds with LEO), the change of propagation delay may not be ignored.

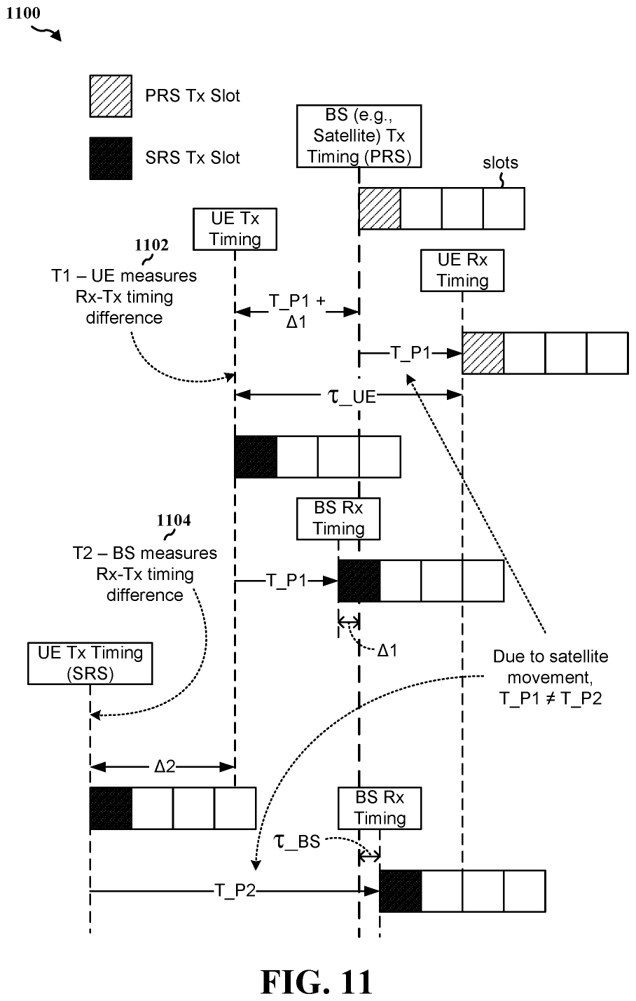

FIG. 11 is a diagram 1100 illustrating an example of calculating an RTT between a UE and a base station in accordance with various aspects of the present disclosure. As shown at 1102, at a first point in time (T1), a base station (e.g., the satellite 1004) may transmit a PRS for a UE (e.g., the UE 1002) to measure the Rx-Tx timing difference τ_{UE}. In some examples, T_{UE}=2T_{P1}+Δ₁, where T_{P1} may indicate the propagation delay at T1 and Δ₁ may indicate a residual UL synchronization error.

As shown at 1104, at a second point in time (T2), the UE may transmit an SRS for the base station to measure the Rx-Tx timing difference τ_{gNB}. If the UE's SRS transmission timing (e.g., UE Tx Timing) relative to the base station's PRS transmission timing (e.g., BS Tx Timing) is changed by Δ₂ due to either autonomous timing advance (TA) adjustment or timing drift, then τ_{gNB}=T_{P2}−(T_{P1}+Δ₁+Δ₂).

Then, an RTT between the base station and the UE may be calculated/estimated by summing τ_{UE} and τ_{gNB}, where RTTₑₛₜ=τ_{UE}+τ_{gNB}=T_{P2}+T_{P1}−Δ₂=2T_{P1}+(Δ_{TP}−Δ₂). If 9Δ_{TP}≠Δ₂ (e.g., the change in propagation delay cannot be fully compensated), by apply UL timing advance at UE, an error (Δ_{TP}−Δ₂) may be added to the estimated RTT.

Aspects presented herein may improve positioning procedures for an NTN, where RTT between a UE and a non-terrestrial device (e.g., an aircraft base station, or a satellite base station, etc.) associated with the NTN may be calculated/estimated with a higher accuracy. Aspects presented herein may enable a positioning entity (e.g., a UE, a base station, a TRP, or an LMF, etc.) to take changes in propagation delay into consideration when calculating RTT or measuring Rx-Tx timing difference for signals transmitted between a UE and a non-terrestrial device.

In one aspect of the present disclosure, a UE may be configured to measure and report a propagation delay change in a positioning session associated with an NTN. For example, the UE may measure time difference of arrival (TDOA) measurements for a set of reference signals transmitted from a non-terrestrial device (e.g., an aircraft base station, or a satellite base station, etc.) over a given timeframe to estimate the propagation delay change (Δ_{TP}) between the non-terrestrial device and UE. For example, Δ_{TP}=T_{PRS,SF}_{ⱼ}−T_{PRS,SF}_{ᵢ} where T_{PRS,SF}_{ᵢ}, and T_{PRS,SF}_{ⱼ} may indicate the arrival time of the measured PRS relative to the received timing of downlink subframes i and j containing a first PRS (PRS #1) and a second PRS (PRS #2), respectively, based on the same reference system timing. In addition, if there is a UE autonomous DL timing adjustment from the reception of the first PRS (e.g., at T1) to the reception of the second PRS (e.g., at T2), the DL system timing change (eT_{Rx}) may also be included. For example, the DL system timing change may be defined as: eT_{Rx,j}=Δ_{DL}(j)−Δ_{DL}(i), where Δ_{DL}(i) and Δ_{DL}(j) may indicate the timing of downlink subframe i and j containing a first PRS (PRS #1) and a second PRS (PRS #2), respectively. The DL system timing change (eT_{Rx}) may be acquired from the UE's internal timing tracking loop. Then, the propagation delay change (Δ_{TP}) may be represented by: Δ_{TP}=T_{PRS,SF}_{ⱼ}−T_{PRS,SF}_{ᵢ}+eT_{Rx,j}.

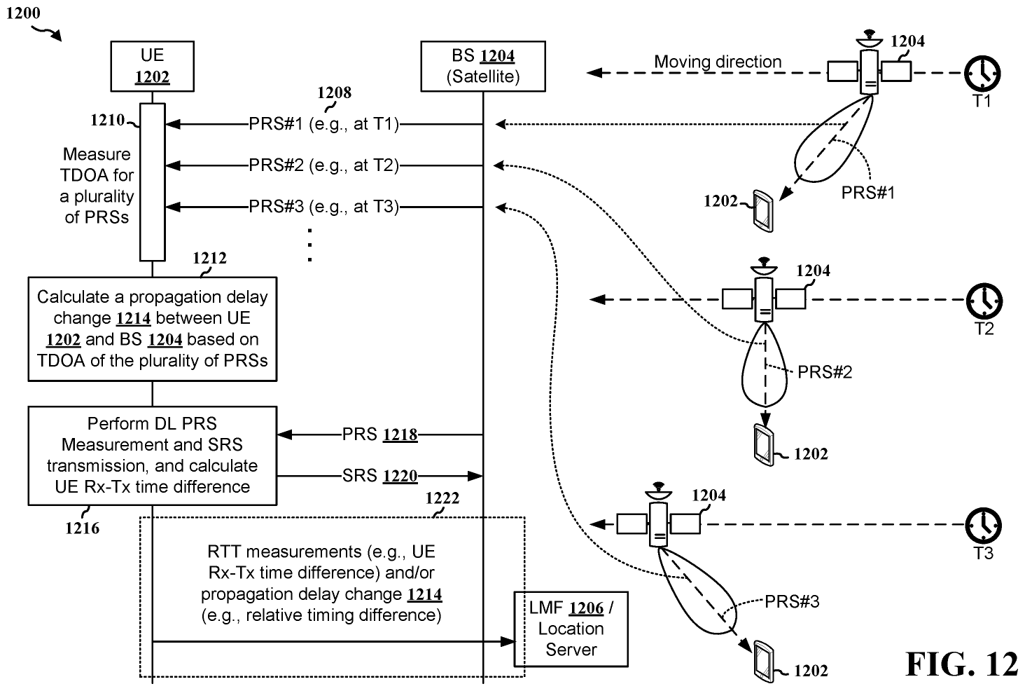

FIG. 12 is a communication flow 1200 illustrating an example of a UE measuring and reporting propagation delay change for a UE positioning session associated with an NTN in accordance with various aspects of the present disclosure. The numberings associated with the communication flow 1200 do not specify a particular temporal order and are merely used as references for the communication flow 1200.

At 1208, a base station 1204 may transmit a plurality of reference signals, such as PRSs, to a UE 1202 over a period of time. For example, the base station 1204 may transmit a first PRS (PRS #1) to the UE 1202 at a first point in time (T1), transmit a second PRS (PRS #2) at a second point in time (T2), transmit a third PRS (PRS #3) at a third point in time (T3), and so on. In one example, the base station 1204 may be a non-terrestrial device that is associated with or is part of an NTN, where the non-terrestrial device may include a satellite, an aircraft, or an airborne object, etc.

At 1210, after receiving the plurality of PRSs from the base station 1204, the UE 1202 may measure the plurality of PRSs, such as measuring the TDOA for the plurality of PRSs received. In some examples, the TDOA may also be referred to as multilateration.

At 1212, the UE 1202 may calculate a propagation delay change 1214 between the UE 1202 and the base station 1204 based on the TDOA of the plurality of PRSs. For example, the UE 1202 may measure the first PRS at T1 to obtain a first PRS reception time, and measure the second PRS at T2 to obtain a second PRS reception time. Then, the UE 1202 may calculate the propagation delay change 1214 based on a difference between the first PRS reception time and the second PRS reception time. In one example, the calculated/estimated propagation delay change (Δ_{TP}) between the UE 1202 and the base station 1204 may be represented by Δ_{TP}=T_{PRS,SF}_{ⱼ}−T_{PRS,SF}_{ᵢ} where T_{PRS,SF}_{ᵢ} and T_{PRS,SF}_{ⱼ} may indicate the arrival time of the measured PRS relative to the received timing of downlink subframes i and j containing the first PRS (PRS #1) and the second PRS (PRS #2).

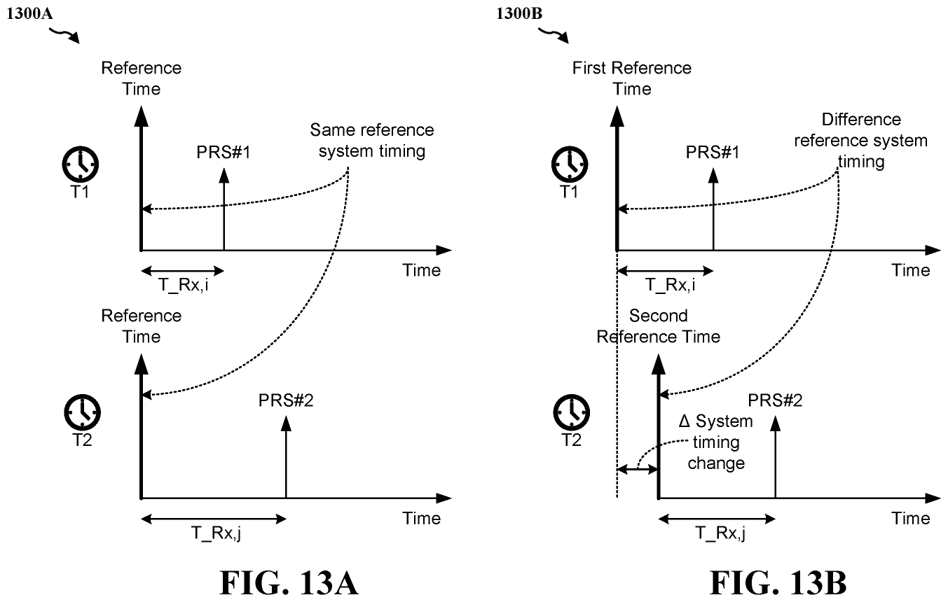

In some examples, the first PRS reception time and the second PRS reception time may be based on a same reference system timing. For example, as shown by a diagram 1300A of FIG. 13A, the UE 1202 may receive the first PRS at the reception time i (e.g., T_{RX,i}) and the second PRS at the reception j (e.g., T_{RXj}). As both PRSs are received with the same reference system timing, there may not be a system timing change. Thus, Δ_{TP}=T_{PRS,SF}_{ⱼ}−T_{PRS,SF}_{ᵢ}

In another example, as shown by a diagram 1300B of FIG. 13B, the first PRS reception time and the second PRS reception time may be based on a first reference system timing and a second reference system timing, respectively. In other words, the first reference system timing may be different from the second reference system timing. In such an example, the UE 1202 may calculate the propagation delay change 1214 further based on a change in the first reference system timing or the second reference system timing (e.g., based on the A system timing change). For example, if there is a UE autonomous DL timing adjustment from the reception of the first PRS (e.g., at T1) to the reception of the second PRS (e.g., at T2), the DL system timing change may also be included. For example, the DL system timing change may be defined as: eT_{Rx,j}−Δ_{DL}(j)−Δ_{DL}(i), where Δ_{DL}(i) and Δ_{DL}(j) may indicate the timing of downlink subframe i and j containing a first PRS (PRS #1) and a second PRS (PRS #2), respectively. The DL system timing change (eT_{Rx}) may be acquired from the UE's internal timing tracking loop. Then, the propagation delay change (Δ_{TP}) may be represented by: Δ_{TP}=T_{PRS,SF}_{ⱼ}−T_{PRS,SF}_{ᵢ}+eT_{Rx,j}.

At 1216, the UE 1202 may perform RTT measurement(s) for a UE positioning session. For example, the UE 1202 may receive a PRS 1218 from the base station 1204, and transmit an SRS 1220 to the base station 1204. Then, the UE 1202 may measure the PRS 1218 to calculate the UE Rx-Tx time difference, such as described in connection with FIG. 9. In some examples, the PRS 1218 may be one or more of the plurality of PRSs received from the base station 1204 at 1208. In other words, the reference signals (e.g., PRSs) received by the UE 1202 for calculating the propagation delay change 1214 may also be used by the UE 1202 for the positioning session. In other examples, the PRS 1218 may be different from the reference signals received by the UE 1202 for calculating the propagation delay change 1214. In other words, the reference signals for calculating the propagation delay change 1214 may be separately configured and transmitted to the UE 1202.

At 1222, the UE 1202 may transmit, to an LMF 1206 and/or a location server, the measured UE Rx-Tx time difference associated for the UE positioning session and the propagation delay change 1214. In some examples, the propagation delay change may also be referred to as the relative timing difference between multiple PRS measurements at different times, which may be defined by T_{PRS,SF}_{ⱼ}−T_{PRS,SF}_{ᵢ}. In other examples, the value range of the relative timing difference may be configured to extend to a larger value range (e.g., tens of ms) if there is a limitation or a maximum value in which the relative timing difference can be (e.g., 3.18 ms). Additionally, or alternatively, the UE 1202 may be configured to report a timing difference value in a range of plus-minus (+/−) 500 us plus an additional slot offset of +/−N slots, N being an integer.

In one example, the LMF 1206 may determine the RTTs from the UE Rx-Tx time difference and BS Rx-Tx time difference from the base station 1204) and/or one or more other base stations and/or TRPs, such as described in connection with FIG. 9. Then, the LMF 1206 may calculate/estimate the position of the UE 1202 based at least in part on the UE Rx-Tx time difference, the BS Rx-Tx time difference, and also the propagation delay change 1214. The UE Rx-Tx time difference may refer to a first time between the UE 1202 receiving the PRS 1218 from the base station 1204 and the UE transmitting the SRS 1220 to the base station 1204, and the BS Rx-Tx time difference may refer to a second time between the BS receiving the SRS 1220 from the UE 1202 and the BS transmitting the PRS 1218 to the UE.

Aspects discussed in connection with FIG. 12 may improve the accuracy and performance of a positioning session involving an NTN, where the positioning session may take changes in propagation delay into consideration when calculating RTT, thereby providing a more accurate RTT calculation and a better UE position estimation.

However, in some scenarios, a channel used for receiving different reference signals (e.g., for receiving PRSs at 1208) may be changed between each reference signal reception. For example, the channel may be changed between a PRS received at subframe i and a PRS received at subframe j. As such, the measured relative timing difference T_{PRS,SF}_{ⱼ}−T_{PRS,SF}_{ᵢ} may further be configured or specified to include the propagation delay difference and also the channel path arrival timing difference. In addition, if an SRS (e.g., the SRS 1220) for BS Rx-Tx time difference is measured on a different subframe, an interpolation may be used to derive the propagation delay on an SRS subframe, which may introduce an estimation error. For example, referring back to FIG. 12, the UE 1202 may receive the PRS 1218 (which may be one of the PRSs received at 1208) in a first subframe (e.g., via a first channel) and transmit the SRS 1220 at a second subframe (e.g., via a second channel). Thus, the base station 1204 may measure the SRS 1220 in a subframe that is different from the PRS 1218. If the LMF 1206 is using the interpolation associated with the first subframe (e.g., associated with the PRS transmission) to derive the propagation delay associated with the SRS reception at the second subframe, an estimation error may occur.

Aspects presented herein may further improve the accuracy of a positioning session associated with an NTN, where the transmission timing of reference signals transmitted from a UE and a non-terrestrial device in a positioning session may be adjusted to be aligned or close in time. As such, the reference signals are more likely to be received based on a similar or a same channel condition or propagation delay.

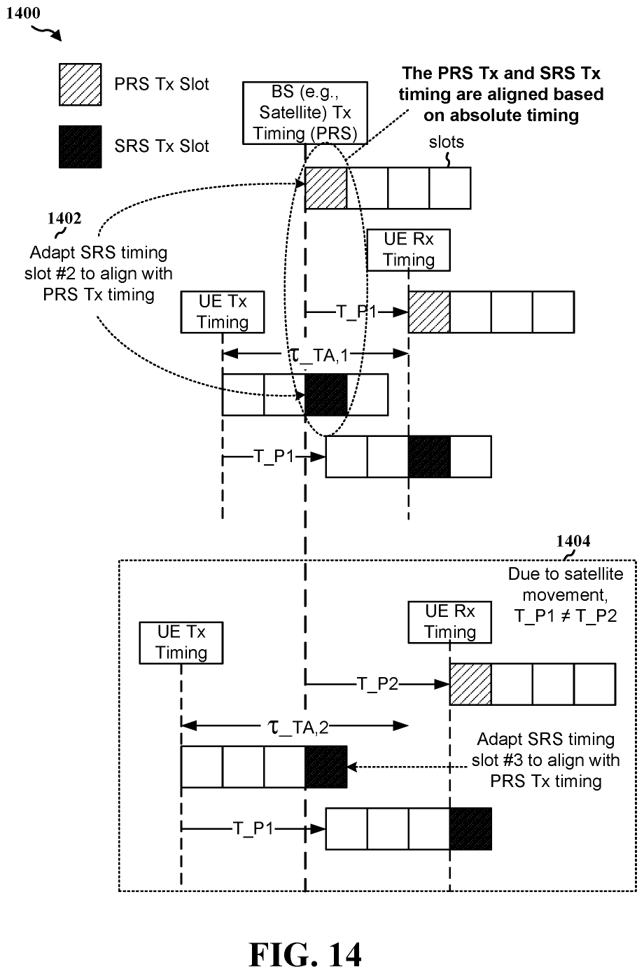

FIG. 14 is a diagram 1400 illustrating an example of a UE aligning its SRS transmission with a PRS transmission from a base station in accordance with various aspects of the present disclosure. In one example, as shown at 1402, if a UE (e.g., the UE 1202) is able to determine the transmission time of a PRS from a base station (e.g., the base station 1204), the UE may align its corresponding SRS transmission with the PRS transmission. For example, if the UE receives the PRS at a first slot (or a first point in time) based on the PRS configuration, the UE may determine that the propagation time (T_{P1}) for the PRS is approximately two slots based on the UL TA at the first point in time, which is configured by the serving base station to a value in between 3-4 slots in the example. Then, the UE may align its SRS transmission with the base station's PRS transmission, such as by transmitting the SRS approximately two slots later relative to the PRS slot index (e.g., slot 0) to use a slot that is closest in time to the transmission of the PRS. In other words, the SRS transmission slot index may be determined based on the PRS slot index and the UL TA to the serving base station. In some scenarios, as UL TA may be applied to UL transmissions including SRS transmissions, in NTN, the UL TA value may be larger including a number of slots plus a fractional offset within the slot. Thus, an SRS Tx slot index may be determined by the PRS slot index and the half value of the slot offset of UL TA, i.e.,

$$floor ( \frac{{Δ}_{i}}{2 * {T}_{s l o t}} ) .$$

Similarly, as shown at 1404, if the UE determines that the propagation time for the PRS is approximately three slots (e.g., the UL TA at the second point in time may be changed to a value in between 5-7 slots), the UE may align its SRS transmission with the base station's PRS transmission, such as by transmitting the SRS approximately three slots later relative to the PRS slot index (e.g., slot 0) to use a slot that is closest in time to the transmission of the PRS. As the PRS and the SRS are transmitted by the base station and the UE, respectively, at approximately the same time or close in time, they are more likely to transmitted based on a similar channel condition, propagation delay, and/or subframe. Thus, if an LMF uses the RTT measurement to derive the UE's location, the estimation error due to the propagation delay change may be less likely to occur or may be avoided.

As such, in some examples, the UE's SRS transmission slot may not be based on the configured periodicityAndSlotOffset parameter (e.g., configured by a serving base station such as described in connection with FIG. 9 at 928), but may be flexibly selected by the UE based on an UL TA to align with the PRS transmission, such as based on a slot closest in time (e.g., absolute timing instead of frame/slot timing) to the PRS slot. In such a way, the UE and the base station may also be able to measure Rx-Tx timing difference almost at the same time or close in time to minimize ambiguity on propagation delay change due to satellite movement. For example, if PRS transmission slot index is indicated by P(i) and an UL TA is indicated by Δᵢ then an SRS transmission slot index may be determined by

$$P ( i ) + floor ( \frac{{Δ}_{i}}{2 * {T}_{s l o t}} )$$

where Tₛₗₒₜ indicates the slot duration.

In some examples, the UE may also be configured to report its own UL TA to the serving base station for the serving base station to determine an UL slot for SRS reception. For example, due to propagation delay, the UE may be specified to report the UL TA in at least a slot earlier than the SRS transmission slot and the reported UL TA may be used by the serving base station for determine the actual SRS transmission slot. In addition, the reported UL TA may be different from the actual UL TA used in the SRS transmission slot if difference in the reported UL TA and actual UL TA used is not big enough to result in a large gap relative to PRS timing.

In another aspect of the present disclosure, the PRS/SRS aligning mechanism described in connection with FIG. 14 may also be applied to a multi-cell RTT scheme, where multiple base stations/TPRs may transmit PRS to a UE for UE Rx-Tx timing measurements.

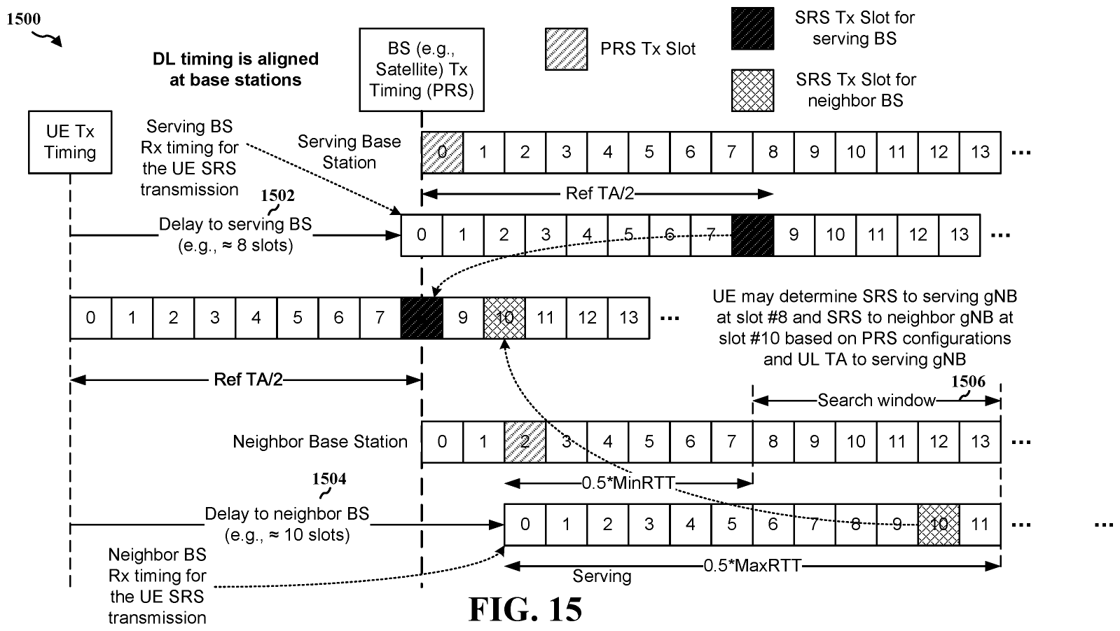

FIG. 15 is a diagram 1500 illustrating an example of a UE aligning its SRS transmissions with PRS transmissions from multiple base stations in accordance with various aspects of the present disclosure. In one example, as shown at 1502, if a UE (e.g., the UE 902, 1202) is able to determine the transmission times of a first PRS from a serving base station (e.g., the base station 904, 1204) and a second PRS from a neighbor base station (e.g., the one or more neighbor BSs/TRPs 908), the UE may align its corresponding SRS transmissions to the serving base station and the neighbor base station with the PRS transmissions. For example, if the UE receives a first PRS from the serving base station at a first slot (or a first point in time), the UE may determine that the propagation time for the first PRS is approximately eight (8) slots based on the UL TA at the first point in time, which may be configured by the serving base station. Then, the UE may align its corresponding SRS transmission with the serving base station's first PRS transmission by transmitting the corresponding SRS approximately eight (8) slots later relative to the PRS slot index (e.g., slot 0) to use a slot that is closest in time to the transmission of the first PRS. As such, the UE and the serving base station may transmit the SRS and the first PRS, respectively, at approximately the same time or close in time (i.e., based on physical timing instead of the SFN and slot index). The UE may also report the UL TA to the serving base station, such that the serving base station may be able to determine a slot for receiving the SRS.

Then, for a synchronous deployment (e.g., DL transmission timing is aligned at the base stations), the UE may also determine an SRS transmission slot for the neighbor base station based on an associated PRS slot index and the UL TA reported to the serving base station. For example, as shown at 1504, as the UE has determined to transmit the SRS corresponding to the first PRS to the serving base station approximately eight (8) slots later relative to the PRS slot index (e.g., slot 0), and the neighbor base station is transmitting the second PRS two (2) slots later than the first PRS, the UE may transmit the SRS corresponding to the second PRS to the neighbor base station approximately ten (10) slots later (e.g., 8+2=10) relative to the PRS slot index (e.g., slot 0). As such, the UE and the neighbor base station may transmit the SRS and the second PRS, respectively, at approximately the same time or close in time. The UE may also report the UL TA to the neighbor base station, such that the neighbor base station may be able to determine a slot for receiving the SRS. In one example, if the neighbor base station is able to decode the UL TA report, the neighbor base station may use the UL TA report to determine an SRS reception slot. However, if the neighbor base station is unable to decode the UL TA report, the neighbor base station may be specified to perform a blind SRS decoding within a search window by configured by a location server (e.g., the LMF 906, 1206). For example, as shown at 1506, the configuration of the search window may be based on a maximum differential delay within an NTN cell (e.g., approximately 3.18 ms for one LEO cell). In addition, the neighbor base station may further be configured to report to the location server if the neighbor base station is unable to detect the SRS within the configured search window.

In another aspect of the present disclosure, the location server may further be configured to maintain PRS transmission timing differences among different base stations and/or cells, such that the location server may ensure configurations for PRS for non-serving cell(s)/base station(s) are not overlapping with SRS measurement intervals. Such configuration may be useful if the non-serving cell(s)/base station(s) are also NTN cells, where frame synchronization with the serving cell/base station may be hard to maintain. Thus, a stable timing difference between the cells/base stations may be specified instead of the frame timing alignment.

In another aspect of the present disclosure, aspects described in connection with FIGS. 12 to 15 may be applied based on the types of positioning methods employed with a network. For example, a first positioning method (e.g., based on RTT measurements) may be applied between a UE and a serving base station, and a second positioning method (e.g., based on OTDOA) may be applied between the UE and one or more neighbor base stations/TRPs, where the one or more neighbor base stations/TRPs may be NTN cells, ground cells (e.g., terrestrial base station/TRP), or a combination of both. In other words, for a positioning session associated with an NTN, multiple or different positioning mechanisms (e.g., as described in connection with FIGS. 4 to 15) may be employed between the UE and the serving base station, and between the UE and the neighbor base stations/TRPs.

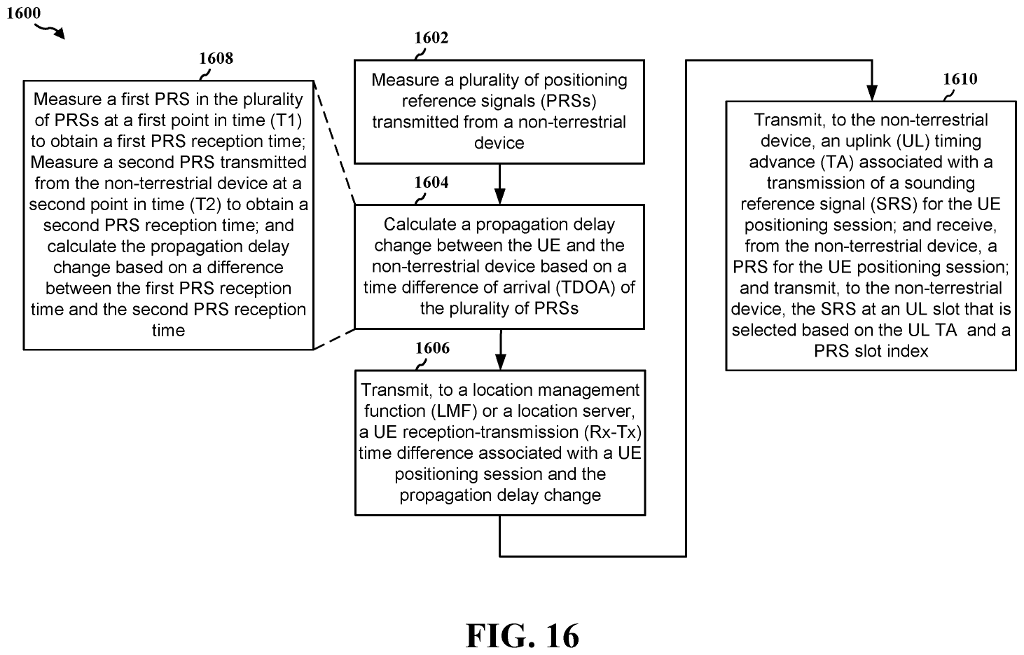

FIG. 16 is a flowchart 1600 of a method of wireless communication. The method may be performed by a UE or a component of a UE (e.g., the UE 104, 350, 404, 602, 704, 804, 902, 1002, 1202; the apparatus 1802; a processing system, which may include the memory 360 and which may be the entire UE 350 or a component of the UE 350, such as the TX processor 368, the RX processor 356, and/or the controller/processor 359). The method may enable the UE to prioritize PRS measurements for TRPs within a frequency layer, PRS resource sets associated with a TRP, and/or PR resources within a PRS resource set based on one or more conditions. Aspects presented herein may improve a UE positioning procedure by enabling the UE to measure changes in propagation delay when the UE is participating in a positioning session associated with a non-terrestrial device. Aspects presented herein may also enable a UE to align its SRS transmission with a PRS transmission of a non-terrestrial device so that the SRS and the PRS may be transmitted close in time based on a similar or a same channel condition or propagation delay.

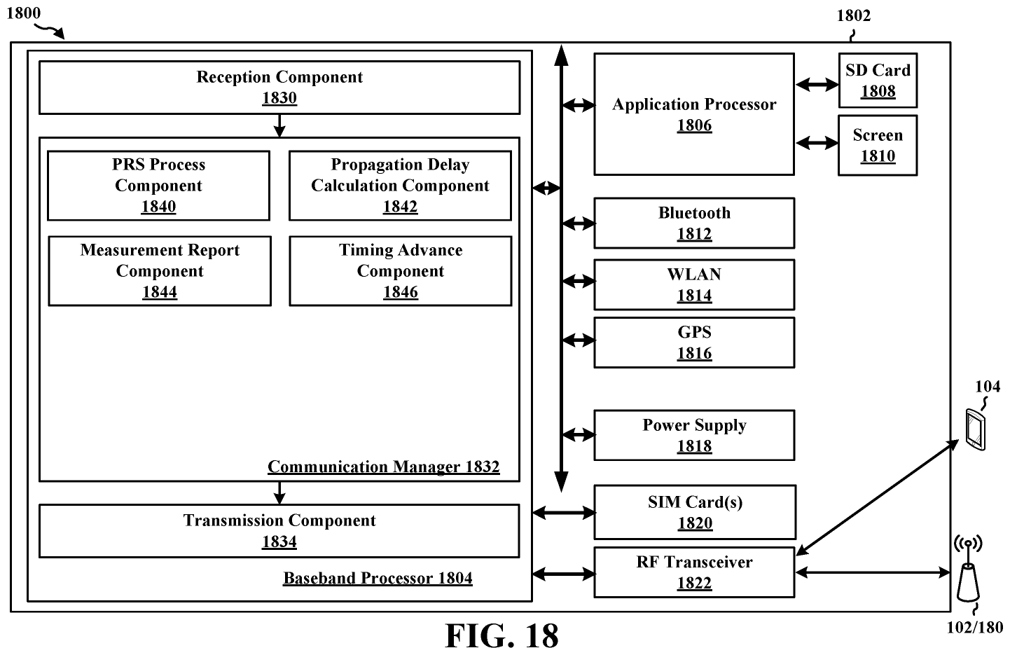

At 1602, the UE may measure a plurality of PRSs transmitted from a non-terrestrial device, such as described in connection with FIGS. 11 to 15. For example, as shown by the communication flow 1200 of FIG. 12, at 1210, the UE 1202 may measure a plurality of PRSs transmitted from a base station 1204, which may be a satellite. The measurement of the plurality of PRS may be performed by, e.g., the PRS process component 1840, the reception component 1830, and/or the RF transceiver 1822 of the apparatus 1802 in FIG. 18. In one example, the non-terrestrial device may include a satellite, an aircraft, or an airborne object. In another example, the non-terrestrial device is a base station associated with a non-terrestrial network.

At 1604, the UE may calculate a propagation delay change between the UE and the non-terrestrial device based on a TDOA of the plurality of PRSs, such as described in connection with FIGS. 11 to 15. For example, as shown by the communication flow 1200 of FIG. 12, at 1212, the UE 1202 may calculate a propagation delay change 1214 between the UE 1202 and the base station 1204 based on TDOA of the plurality of PRSs. The calculation of the propagation delay may be performed by, e.g., the propagation delay calculation component 1842 of the apparatus 1802 in FIG. 18.

At 1606, the UE may transmit, to an LMF or a location server, a UE Rx-Tx time difference associated with a UE positioning session and the propagation delay change, such as described in connection with FIGS. 11 to 15. For example, as shown by the communication flow 1200 of FIG. 12, at 1222, the UE 1202 may transmit RTT measurements (e.g., UE Rx-Tx time difference) and the propagation delay change 1214 (e.g., relative timing difference) to the base station 1204, the LMF 1206, and/or a location server. The transmission of the UE Rx-Tx time difference and the propagation delay change may be performed by, e.g., the measurement report component 1844, the transmission component 1834, and/or the RF transceiver 1822 of the apparatus 1802 in FIG. 18.

In one example, a distance between the UE and the non-terrestrial device may be estimated based at least in part on the UE Rx-Tx time difference, the propagation delay change, and a non-terrestrial device Rx-Tx time difference. In such an example, the UE Rx-Tx time difference may be a first time between the UE receiving a PRS from the non-terrestrial device and the UE transmitting a corresponding SRS to the non-terrestrial device, and the non-terrestrial device Rx-Tx time difference may be a second time between the non-terrestrial device receiving the SRS from the UE and the non-terrestrial device transmitting the PRS to the UE. In such an example, the PRS may be included in the plurality of PRSs.

As shown at 1608, to calculate the propagation delay change between the UE and the non-terrestrial device based on the TDOA of the plurality of PRSs, the UE may measure a first PRS in the plurality of PRSs at a first point in time (T1) to obtain a first PRS reception time; measure a second PRS transmitted from the non-terrestrial device at a second point in time (T2) to obtain a second PRS reception time; and calculate the propagation delay change based on a difference between the first PRS reception time and the second PRS reception time, such as described in connection with FIGS. 11 and 12.

In one example, the first PRS reception time and the second PRS reception time may be based on a same reference system timing, such as described in connection with FIG. 13A.

In another example, the first PRS reception time and the second PRS reception time may be based on a first reference system timing and a second reference system timing, respectively, such as described in connection with FIG. 13B. In such an example, the first reference system timing may be different from the second reference system timing. In such an example, the UE may calculate the propagation delay change further based on a change in the first reference system timing or the second reference system timing.

At 1610, the UE may transmit, to the non-terrestrial device, an UL TA associated with a transmission of an SRS for the UE positioning session; receive, from the non-terrestrial device, a PRS for the UE positioning session; and transmit, to the non-terrestrial device, the SRS at an UL slot that is selected based on the UL TA and a PRS slot index, such as described in connection with FIGS. 14 and 15. For example, as shown by the diagram 1400 of FIG. 14, at 1402, a UE may apply an UL TA to its SRS transmission to align the SRS transmission with a PRS transmission from a base station. Then, the UE may report its UL TA to the base station, such that the base station may be able to determine a slot for receiving the SRS. The transmission of the UL TA and/or the SRS based on the UL TA may be performed by, e.g., the timing advance component 1846, the transmission component 1834, and/or the RF transceiver 1822 of the apparatus 1802 in FIG. 18. In one example, the UE may identify the UL slot for transmitting the SRS based on the UL TA.

In another example, the UL TA may align a transmission timing of the SRS to a transmission timing of the PRS based on a physical timing. In such an example, the UL TA may align the transmission timing of the SRS to a slot that is closest in time to the transmission timing of the PRS.

In another example, the UL slot for transmitting the configuration for SRS transmission for the UE positioning session is not associated with a time domain resource configuration.

In another example, the UE may transmit, to a non-serving base station associated with the UE positioning session, an indication of an SRS transmission slot for transmitting a second SRS to the non-serving base station, the SRS transmission slot being determined based at least in part on the UL TA and the PRS slot index, the UE may receive, from the non-serving base station, a second PRS for the UE positioning session, and the UE may transmit, to the non-serving base station, the second SRS based on the SRS transmission slot.

In another example, the UE may receive, from the non-terrestrial device, a first PRS for the UE positioning session; and the UE may receive, from a non-serving base station, a second PRS for the UE positioning session, where the first PRS and the second PRS may be received based on a PRS timing difference between the non-terrestrial device and the non-serving base station maintained by the LMF. In such an example, the non-serving base station is a second non-terrestrial device. In such an example, a first distance between the UE and the non-terrestrial device may be calculated based on a first positioning method, and a second distance between the UE and the non-serving base station is calculated based on a second positioning method, the second positioning method may be different from the first positioning method.

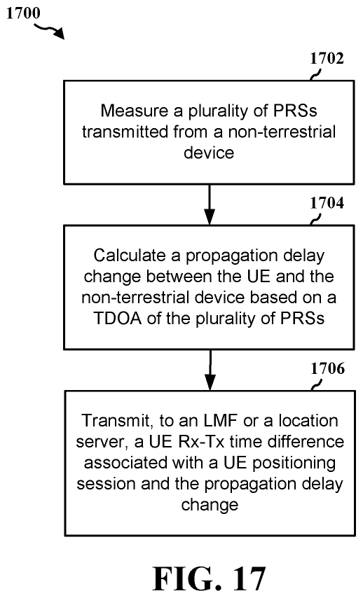

FIG. 17 is a flowchart 1700 of a method of wireless communication. The method may be performed by a UE or a component of a UE (e.g., the UE 104, 350, 404, 602, 704, 804, 902, 1002, 1202; the apparatus 1802; a processing system, which may include the memory 360 and which may be the entire UE 350 or a component of the UE 350, such as the TX processor 368, the RX processor 356, and/or the controller/processor 359). The method may enable the UE to prioritize PRS measurements for TRPs within a frequency layer, PRS resource sets associated with a TRP, and/or PR resources within a PRS resource set based on one or more conditions. Aspects presented herein may improve a UE positioning procedure by enabling the UE to measure changes in propagation delay when the UE is participating in a positioning session associated with a non-terrestrial device. Aspects presented herein may also enable a UE to align its SRS transmission with a PRS transmission of a non-terrestrial device so that the SRS and the PRS may be transmitted close in time based on a similar or a same channel condition or propagation delay.

At 1702, the UE may measure a plurality of PRSs transmitted from a non-terrestrial device, such as described in connection with FIGS. 11 to 15. For example, as shown by the communication flow 1200 of FIG. 12, at 1210, the UE 1202 may measure a plurality of PRSs transmitted from a base station 1204, which may be a satellite. The measurement of the plurality of PRS may be performed by, e.g., the PRS process component 1840, the reception component 1830, and/or the RF transceiver 1822 of the apparatus 1802 in FIG. 18. In one example, the non-terrestrial device may include a satellite, an aircraft, or an airborne object. In another example, the non-terrestrial device is a base station associated with a non-terrestrial network.

At 1704, the UE may calculate a propagation delay change between the UE and the non-terrestrial device based on a TDOA of the plurality of PRSs, such as described in connection with FIGS. 11 to 15. For example, as shown by the communication flow 1200 of FIG. 12, at 1212, the UE 1202 may calculate a propagation delay change 1214 between the UE 1202 and the base station 1204 based on TDOA of the plurality of PRSs. The calculation of the propagation delay may be performed by, e.g., the propagation delay calculation component 1842 of the apparatus 1802 in FIG. 18.

At 1706, the UE may transmit, to an LMF or a location server, a UE Rx-Tx time difference associated with a UE positioning session and the propagation delay change, such as described in connection with FIGS. 11 to 15. For example, as shown by the communication flow 1200 of FIG. 12, at 1222, the UE 1202 may transmit RTT measurements (e.g., UE Rx-Tx time difference) and the propagation delay change 1214 (e.g., relative timing difference) to the base station 1204, the LMF 1206, and/or a location server. The transmission of the UE Rx-Tx time difference and the propagation delay change may be performed by, e.g., the measurement report component 1844, the transmission component 1834, and/or the RF transceiver 1822 of the apparatus 1802 in FIG. 18.

In one example, a distance between the UE and the non-terrestrial device may be estimated based at least in part on the UE Rx-Tx time difference, the propagation delay change, and a non-terrestrial device Rx-Tx time difference. In such an example, the UE Rx-Tx time difference may be a first time between the UE receiving a PRS from the non-terrestrial device and the UE transmitting a corresponding SRS to the non-terrestrial device, and the non-terrestrial device Rx-Tx time difference may be a second time between the non-terrestrial device receiving the SRS from the UE and the non-terrestrial device transmitting the PRS to the UE. In such an example, the PRS may be included in the plurality of PRSs.

In another example, to calculate the propagation delay change between the UE and the non-terrestrial device based on the TDOA of the plurality of PRSs, the UE may measure a first PRS in the plurality of PRSs at a first point in time (T1) to obtain a first PRS reception time; measure a second PRS transmitted from the non-terrestrial device at a second point in time (T2) to obtain a second PRS reception time; and calculate the propagation delay change based on a difference between the first PRS reception time and the second PRS reception time, such as described in connection with FIGS. 11 and 12.

In one example, the first PRS reception time and the second PRS reception time may be based on a same reference system timing, such as described in connection with FIG. 13A.

In another example, the first PRS reception time and the second PRS reception time may be based on a first reference system timing and a second reference system timing, respectively, such as described in connection with FIG. 13B. In such an example, the first reference system timing may be different from the second reference system timing. In such an example, the UE may calculate the propagation delay change further based on a change in the first reference system timing or the second reference system timing.

In another example, the UE may transmit, to the non-terrestrial device, an UL TA associated with a transmission of an SRS for the UE positioning session; receive, from the non-terrestrial device, a PRS for the UE positioning session; and transmit, to the non-terrestrial device, the SRS at an UL slot that is selected based on the UL TA and a PRS slot index, such as described in connection with FIGS. 14 and 15. For example, as shown by the diagram 1400 of FIG. 14, at 1402, a UE may apply an UL TA to its SRS transmission to align the SRS transmission with a PRS transmission from a base station. Then, the UE may report its UL TA to the base station, such that the base station may be able to determine a slot for receiving the SRS. The transmission of the UL TA and/or the SRS based on the UL TA may be performed by, e.g., the timing advance component 1846, the transmission component 1834, and/or the RF transceiver 1822 of the apparatus 1802 in FIG. 18. In one example, the UE may identify the UL slot for transmitting the SRS based on the UL TA.

In another example, the UL TA may align a transmission timing of the SRS to a transmission timing of the PRS based on a physical timing. In such an example, the UL TA may align the transmission timing of the SRS to a slot that is closest in time to the transmission timing of the PRS.

In another example, the UL slot for transmitting the configuration for SRS transmission for the UE positioning session is not associated with a time domain resource configuration.

In another example, the UE may transmit, to a non-serving base station associated with the UE positioning session, an indication of an SRS transmission slot for transmitting a second SRS to the non-serving base station, the SRS transmission slot being determined based at least in part on the UL TA and the PRS slot index, the UE may receive, from the non-serving base station, a second PRS for the UE positioning session, and the UE may transmit, to the non-serving base station, the second SRS based on the SRS transmission slot.

In another example, the UE may receive, from the non-terrestrial device, a first PRS for the UE positioning session; and the UE may receive, from a non-serving base station, a second PRS for the UE positioning session, where the first PRS and the second PRS may be received based on a PRS timing difference between the non-terrestrial device and the non-serving base station maintained by the LMF. In such an example, the non-serving base station is a second non-terrestrial device. In such an example, a first distance between the UE and the non-terrestrial device may be calculated based on a first positioning method, and a second distance between the UE and the non-serving base station is calculated based on a second positioning method, the second positioning method may be different from the first positioning method.

FIG. 18 is a diagram 1800 illustrating an example of a hardware implementation for an apparatus 1802. The apparatus 1802 may be a UE, a component of a UE, or may implement UE functionality. In some aspects, the apparatus 1802 may include a baseband processor 1804 (also referred to as a modem) coupled to an RF transceiver 1822. In some aspects, the apparatus 1802 may further include one or more subscriber identity modules (SIM) cards 1820, an application processor 1806 coupled to a secure digital (SD) card 1808 and a screen 1810, a Bluetooth module 1812, a wireless local area network (WLAN) module 1814, a Global Positioning System (GPS) module 1816, or a power supply 1818. The baseband processor 1804 communicates through the RF transceiver 1822 with the UE 104 and/or BS 102/180. The baseband processor 1804 may include a computer-readable medium/memory. The computer-readable medium/memory may be non-transitory. The baseband processor 1804 is responsible for general processing, including the execution of software stored on the computer-readable medium/memory. The software, when executed by the baseband processor 1804, causes the baseband processor 1804 to perform the various functions described supra. The computer-readable medium/memory may also be used for storing data that is manipulated by the baseband processor 1804 when executing software. The baseband processor 1804 further includes a reception component 1830, a communication manager 1832, and a transmission component 1834. The communication manager 1832 includes the one or more illustrated components. The components within the communication manager 1832 may be stored in the computer-readable medium/memory and/or configured as hardware within the baseband processor 1804. The baseband processor 1804 may be a component of the UE 350 and may include the memory 360 and/or at least one of the TX processor 368, the RX processor 356, and the controller/processor 359. In one configuration, the apparatus 1802 may be a modem chip and include just the baseband processor 1804, and in another configuration, the apparatus 1802 may be the entire UE (e.g., see 350 of FIG. 3) and include the additional modules of the apparatus 1802.

The communication manager 1832 includes a PRS process component 1840 that is configured to measure a plurality of PRSs transmitted from a non-terrestrial device, e.g., as described in connection with 1602 of FIGS. 16 and/or 1702 of FIG. 17. The communication manager 1832 further includes a propagation delay calculation component 1842 that is configured to calculate a propagation delay change between the UE and the non-terrestrial device based on a TDOA of the plurality of PRSs, e.g., as described in connection with 1604 of FIGS. 16 and/or 1704 of FIG. 17. The communication manager 1832 further includes a measurement report component 1844 that is configured to transmit, to an LMF or a location server, a UE Rx-Tx time difference associated with a UE positioning session and the propagation delay change, e.g., as described in connection with 1606 of FIGS. 16 and/or 1706 of FIG. 17. The communication manager 1832 further includes a timing advance component 1846 that is configured to transmit, to the non-terrestrial device, an UL TA associated with a transmission of an SRS for the UE positioning session; receive, from the non-terrestrial device, a PRS for the UE positioning session; and transmit, to the non-terrestrial device, the SRS at an UL slot that is selected based on the UL TA and a PRS slot index, e.g., as described in connection with 1610 of FIG. 16.

The apparatus may include additional components that perform each of the blocks of the algorithm in the flowcharts of FIGS. 16 and 17. As such, each block in the flowcharts of FIGS. 16 and 17 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1802 may include a variety of components configured for various functions. In one configuration, the apparatus 1802, and in particular the baseband processor 1804, includes means for measuring a plurality of PRSs transmitted from a non-terrestrial device (e.g., the PRS process component 1840, the reception component 1830, the RF transceiver 1822, and/or the baseband processor 1804). The apparatus 1802 includes means for calculating a propagation delay change between the UE and the non-terrestrial device based on a TDOA of the plurality of PRSs (e.g., the propagation delay calculation component 1842 and/or the baseband processor 1804). The apparatus 1802 includes means for transmitting, to an LMF or a location server, a UE Rx-Tx time difference associated with a UE positioning session and the propagation delay change (e.g., the measurement report component 1844, the transmission component 1834, the baseband processor 1804, and/or the RF transceiver 1822). The apparatus 1802 includes means for transmitting, to the non-terrestrial device, an UL TA associated with a transmission of an SRS for the UE positioning session, means for receiving, from the non-terrestrial device, a PRS for the UE positioning session, and means for transmitting, to the non-terrestrial device, the SRS at an UL slot that is selected based on the UL TA and a PRS slot index (e.g., the timing advance component 1846, the reception component 1830, the transmission component 1834, the baseband processor 1804, and/or the RF transceiver 1822).

In one configuration, a distance between the UE and the non-terrestrial device may be estimated based at least in part on the UE Rx-Tx time difference, the propagation delay change, and a non-terrestrial device Rx-Tx time difference. In such a configuration, the UE Rx-Tx time difference may be a first time between the UE receiving a PRS from the non-terrestrial device and the UE transmitting a corresponding SRS to the non-terrestrial device, and the non-terrestrial device Rx-Tx time difference may be a second time between the non-terrestrial device receiving the SRS from the UE and the non-terrestrial device transmitting the PRS to the UE. In such a configuration, the PRS may be included in the plurality of PRSs

In another configuration, to calculate the propagation delay change between the UE and the non-terrestrial device based on the TDOA of the plurality of PRSs, the apparatus 1802 includes means for measuring a first PRS in the plurality of PRSs at a first point in time (T1) to obtain a first PRS reception time; means for measuring a second PRS transmitted from the non-terrestrial device at a second point in time (T2) to obtain a second PRS reception time; and means for calculating the propagation delay change based on a difference between the first PRS reception time and the second PRS reception time.

In another configuration, the first PRS reception time and the second PRS reception time may be based on a same reference system timing.

In another configuration, the first PRS reception time and the second PRS reception time may be based on a first reference system timing and a second reference system timing, respectively. In such a configuration, the first reference system timing may be different from the second reference system timing. In such a configuration, the UE may calculate the propagation delay change further based on a change in the first reference system timing or the second reference system timing.

In another configuration, the UL TA may align a transmission timing of the SRS to a transmission timing of the PRS based on a physical timing. In such a configuration, the UL TA may align the transmission timing of the SRS to a slot that is closest in time to the transmission timing of the PRS.

In another configuration, the apparatus 1802 includes means for transmitting, to a non-serving base station associated with the UE positioning session, an indication of an SRS transmission slot for transmitting a second SRS to the non-serving base station, the SRS transmission slot being determined based at least in part on the UL TA and the PRS slot index, means for receiving, from the non-serving base station, a second PRS for the UE positioning session, and means for transmitting, to the non-serving base station, the second SRS based on the SRS transmission slot.

In another configuration, the apparatus 1802 includes means for receiving, from the non-terrestrial device, a first PRS for the UE positioning session; and means for receiving, from a non-serving base station, a second PRS for the UE positioning session, where the first PRS and the second PRS may be received based on a PRS timing difference between the non-terrestrial device and the non-serving base station maintained by the LMF. In such a configuration, the non-serving base station is a second non-terrestrial device. In such a configuration, a first distance between the UE and the non-terrestrial device may be calculated based on a first positioning method, and a second distance between the UE and the non-serving base station is calculated based on a second positioning method, the second positioning method may be different from the first positioning method.

The means may be one or more of the components of the apparatus 1802 configured to perform the functions recited by the means. As described supra, the apparatus 1802 may include the TX Processor 368, the RX Processor 356, and the controller/processor 359. As such, in one configuration, the means may be the TX Processor 368, the RX Processor 356, and the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication including at least one processor coupled to a memory and a transceiver and configured to measure a plurality of PRSs transmitted from a non-terrestrial device; calculate a propagation delay change between the UE and the non-terrestrial device based on a TDOA of the plurality of PRSs; and transmit, to an LMF or a location server, a UE Rx-Tx time difference associated with a UE positioning session and the propagation delay change.

Aspect 2 is the apparatus of aspect 1, where to calculate the propagation delay change between the UE and the non-terrestrial device based on the TDOA of the plurality of PRSs, the at least one processor is further configured to: measure a first PRS in the plurality of PRSs at a first point in time (T1) to obtain a first PRS reception time; measure a second PRS transmitted from the non-terrestrial device at a second point in time (T2) to obtain a second PRS reception time; and calculate the propagation delay change based on a difference between the first PRS reception time and the second PRS reception time.

Aspect 3 is the apparatus of any of aspects 1 and 2, where the first PRS reception time and the second PRS reception time are based on a same reference system timing.

Aspect 4 is the apparatus of any of aspects 1 to 3, where the first PRS reception time and the second PRS reception time are based on a first reference system timing and a second reference system timing, respectively, where the first reference system timing is different from the second reference system timing, the at least one processor is further configured to: calculate the propagation delay change further based on a change in the first reference system timing or the second reference system timing.

Aspect 5 is the apparatus of any of aspects 1 to 4, where a distance between the UE and the non-terrestrial device is estimated based at least in part on the UE Rx-Tx time difference, the propagation delay change, and a non-terrestrial device Rx-Tx time difference.

Aspect 6 is the apparatus of any of aspects 1 to 5, where the UE Rx-Tx time difference is a first time between the UE receiving a PRS from the non-terrestrial device and the UE transmitting a corresponding SRS to the non-terrestrial device, and the non-terrestrial device Rx-Tx time difference is a second time between the non-terrestrial device receiving the SRS from the UE and the non-terrestrial device transmitting the PRS to the UE.

Aspect 7 is the apparatus of any of aspects 1 to 6, where the PRS is included in the plurality of PRSs.

Aspect 8 is the apparatus of any of aspects 1 to 7, where the non-terrestrial device includes a satellite, an aircraft, or an airborne object.

Aspect 9 is the apparatus of any of aspects 1 to 8, where the non-terrestrial device is a base station associated with an NTN.

Aspect 10 is the apparatus of any of aspects 1 to 9, where the at least one processor and the memory are further configured to: transmit, to the non-terrestrial device, an UL TA associated with a transmission of an SRS for the UE positioning session; receive, from the non-terrestrial device, a PRS for the UE positioning session; and transmit, to the non-terrestrial device, the SRS at an UL slot that is selected based on the UL TA and a PRS slot index.

Aspect 11 is the apparatus of any of aspects 1 to 10, where a transmission timing of the SRS to a transmission timing of the PRS is aligned based on a physical timing.

Aspect 12 is the apparatus of any of aspects 1 to 11, where the transmission timing of the SRS is aligned to a slot that is closest in time to the transmission timing of the PRS.

Aspect 13 is the apparatus of any of aspects 1 to 12, where the at least one processor is further configured to: identify the UL slot for transmitting the SRS based on the UL TA.

Aspect 14 is the apparatus of any of aspects 1 to 13, where the UL slot for transmitting the configuration for SRS transmission for the UE positioning session is not associated with a time domain resource configuration.

Aspect 15 is the apparatus of any of aspects 1 to 14, where the at least one processor is further configured to: transmit, to a non-serving base station associated with the UE positioning session, an indication of an SRS transmission slot for transmitting a second SRS to the non-serving base station, the SRS transmission slot being determined based at least in part on the UL TA and the PRS slot index; receive, from the non-serving base station, a second PRS for the UE positioning session; and transmit, to the non-serving base station, the second SRS based on the SRS transmission slot.

Aspect 16 is the apparatus of any of aspects 1 to 15, where the at least one processor and the memory are further configured to: receive, from the non-terrestrial device, a first PRS for the UE positioning session; and receive, from a non-serving base station, a second PRS for the UE positioning session, where the first PRS and the second PRS are received based on a PRS timing difference between the non-terrestrial device and the non-serving base station maintained by the LMF.

Aspect 17 is the apparatus of any of aspects 1 to 16, where the non-serving base station is a second non-terrestrial device.

Aspect 18 is the apparatus of any of aspects 1 to 17, where a first distance between the UE and the non-terrestrial device is calculated based on a first positioning method, and a second distance between the UE and the non-serving base station is calculated based on a second positioning method, the second positioning method being different from the first positioning method.

Aspect 19 is a method of wireless communication for implementing any of aspects 1 to 18.

Aspect 20 is an apparatus for wireless communication including means for implementing any of aspects 1 to 18.

Aspect 21 is a computer-readable medium storing computer executable code, where the code when executed by a processor causes the processor to implement any of aspects 1 to 18.

What is claimed is:

1. An apparatus for wireless communication at a user equipment (UE), comprising:
a memory;
a transceiver; and
at least one processor communicatively connected to the memory and the transceiver, the at least one processor configured to:
measure a plurality of positioning reference signals (PRSs) transmitted from a non-terrestrial device;
calculate a propagation delay change between the UE and the non-terrestrial device based on a time difference of arrival (TDOA) of the plurality of PRSs; and
transmit, to a location management function (LMF) or a location server, a UE reception-transmission (Rx-Tx) time difference associated with a UE positioning session and the propagation delay change.

2. The apparatus of claim 1, wherein to calculate the propagation delay change between the UE and the non-terrestrial device based on the TDOA of the plurality of PRSs, the at least one processor is further configured to:
measure a first PRS in the plurality of PRSs at a first point in time (T1) to obtain a first PRS reception time;
measure a second PRS transmitted from the non-terrestrial device at a second point in time (T2) to obtain a second PRS reception time; and
calculate the propagation delay change based on a difference between the first PRS reception time and the second PRS reception time.

3. The apparatus of claim 2, wherein the first PRS reception time and the second PRS reception time are based on a same reference system timing.

4. The apparatus of claim 2, wherein the first PRS reception time and the second PRS reception time are based on a first reference system timing and a second reference system timing, respectively, wherein the first reference system timing is different from the second reference system timing, the at least one processor is further configured to:
calculate the propagation delay change further based on a change in the first reference system timing or the second reference system timing.

5. The apparatus of claim 1, wherein a distance between the UE and the non-terrestrial device is estimated based at least in part on the UE Rx-Tx time difference, the propagation delay change, and a non-terrestrial device Rx-Tx time difference.

6. The apparatus of claim 5, wherein the UE Rx-Tx time difference is a first time between the UE receiving a PRS from the non-terrestrial device and the UE transmitting a corresponding sounding reference signal (SRS) to the non-terrestrial device, and the non-terrestrial device Rx-Tx time difference is a second time between the non-terrestrial device receiving the SRS from the UE and the non-terrestrial device transmitting the PRS to the UE.

7. The apparatus of claim 6, wherein the PRS is included in the plurality of PRSs.

8. The apparatus of claim 1, wherein the non-terrestrial device includes a satellite, an aircraft, or an airborne object.

9. The apparatus of claim 1, wherein the non-terrestrial device is a base station associated with a non-terrestrial network (NTN).

10. The apparatus of claim 1, wherein the at least one processor is further configured to:
transmit, to the non-terrestrial device, an uplink (UL) timing advance (TA) associated with a transmission of a sounding reference signal (SRS) for the UE positioning session;
receive, from the non-terrestrial device, a PRS for the UE positioning session; and
transmit, to the non-terrestrial device, the SRS at an UL slot that is selected based on the UL TA and a PRS slot index.

11. The apparatus of claim 10, wherein a first transmission timing of the SRS to a second transmission timing of the PRS is aligned based on a physical timing.

12. The apparatus of claim 11, wherein the first transmission timing of the SRS is aligned to a slot that is closest in time to the second transmission timing of the PRS.

13. The apparatus of claim 10, wherein the at least one processor is further configured to:
identify the UL slot for transmitting the SRS based on the UL TA.

14. The apparatus of claim 10, wherein the UL slot for transmitting the SRS for the UE positioning session is not associated with a time domain resource configuration.

15. The apparatus of claim 10, wherein the at least one processor is further configured to:
transmit, to a non-serving base station associated with the UE positioning session, an indication of an SRS transmission slot for transmitting a second SRS to the non-serving base station, the SRS transmission slot being determined based at least in part on the UL TA and the PRS slot index;
receive, from the non-serving base station, a second PRS for the UE positioning session; and
transmit, to the non-serving base station, the second SRS based on the SRS transmission slot.

16. The apparatus of claim 1, wherein the at least one processor is further configured to:
receive, from the non-terrestrial device, a first PRS for the UE positioning session; and
receive, from a non-serving base station, a second PRS for the UE positioning session, wherein the first PRS and the second PRS are received based on a PRS timing difference between the non-terrestrial device and the non-serving base station maintained by the LMF.

17. The apparatus of claim 16, wherein the non-serving base station is a second non-terrestrial device.

18. The apparatus of claim 16, wherein a first distance between the UE and the non-terrestrial device is calculated based on a first positioning method, and a second distance between the UE and the non-serving base station is calculated based on a second positioning method, the second positioning method being different from the first positioning method.

19. A method of wireless communication at a user equipment (UE), comprising:
measuring a plurality of positioning reference signals (PRSs) transmitted from a non-terrestrial device;
calculating a propagation delay change between the UE and the non-terrestrial device based on a time difference of arrival (TDOA) of the plurality of PRSs; and
transmitting, to a location management function (LMF) or a location server, a UE reception-transmission (Rx-Tx) time difference associated with a UE positioning session and the propagation delay change.

20. The method of claim 19, further comprising:
measuring a first PRS in the plurality of PRSs at a first point in time (T1) to obtain a first PRS reception time;
measuring a second PRS transmitted from the non-terrestrial device at a second point in time (T2) to obtain a second PRS reception time; and
calculating the propagation delay change based on a difference between the first PRS reception time and the second PRS reception time.

21. The method of claim 20, wherein the first PRS reception time and the second PRS reception time are based on a first reference system timing and a second reference system timing, respectively, wherein the first reference system timing is different from the second reference system timing, the method further comprising:
calculating the propagation delay change further based on a change in the first reference system timing or the second reference system timing.

22. The method of claim 19, wherein the non-terrestrial device includes a satellite, an aircraft, or an airborne object.

23. The method of claim 19, wherein the non-terrestrial device is a base station associated with a non-terrestrial network (NTN).

24. The method of claim 19, further comprising:
transmitting, to the non-terrestrial device, an uplink (UL) timing advance (TA) associated with a transmission of a sounding reference signal (SRS) for the UE positioning session;
receiving, from the non-terrestrial device, a PRS for the UE positioning session; and
transmitting, to the non-terrestrial device, the SRS at an UL slot that is selected based on the UL TA and a PRS slot index.

25. The method of claim 24, further comprising:
identifying the UL slot for transmitting the SRS based on the UL TA.

26. The method of claim 24, further comprising:
transmitting, to a non-serving base station associated with the UE positioning session, an indication of an SRS transmission slot for transmitting a second SRS to the non-serving base station, the SRS transmission slot being determined based at least in part on the UL TA and the PRS slot index;
receiving, from the non-serving base station, a second PRS for the UE positioning session; and
transmitting, to the non-serving base station, the second SRS based on the SRS transmission slot.

27. The method of claim 19, further comprising:
receiving, from the non-terrestrial device, a first PRS for the UE positioning session; and
receiving, from a non-serving base station, a second PRS for the UE positioning session, wherein the first PRS and the second PRS are received based on a PRS timing difference between the non-terrestrial device and the non-serving base station maintained by the LMF.

28. The method of claim 27, wherein a first distance between the UE and the non-terrestrial device is calculated based on a first positioning method, and a second distance between the UE and the non-serving base station is calculated based on a second positioning method, the second positioning method being different from the first positioning method.

29. An apparatus for wireless communication at a user equipment (UE), comprising:
means for measuring a plurality of positioning reference signals (PRSs) transmitted from a non-terrestrial device;
means for calculating a propagation delay change between the UE and the non-terrestrial device based on a time difference of arrival (TDOA) of the plurality of PRSs; and
means for transmitting, to a location management function (LMF) or a location server, a UE reception-transmission (Rx-Tx) time difference associated with a UE positioning session and the propagation delay change.

30. A computer-readable medium storing computer executable code at a user equipment (UE), the code when executed by a processor causes the processor to:
measure a plurality of positioning reference signals (PRSs) transmitted from a non-terrestrial device;
calculate a propagation delay change between the UE and the non-terrestrial device based on a time difference of arrival (TDOA) of the plurality of PRSs; and
transmit, to a location management function (LMF) or a location server, a UE reception-transmission (Rx-Tx) time difference associated with a UE positioning session and the propagation delay change.
